(19) United States
(12) Patent Application Publication
(10) Pub. No.: US 2013/0028174 A1
(43) Pub. Date: Jan. 31, 2013

(54) USE OF A META LANGUAGE FOR PROCESSING OF AVIATION RELATED MESSAGES

(71) Applicant: Ralf Cabos, Singapore (SG)

(72) Inventor: Ralf Cabos, Singapore (SG)

(73) Assignee: FLIGHT FOCUS PTE. LTD., (SG)

(21) Appl. No.: 13/640,702

(22) PCT Filed: Apr. 12, 2011
(86) PCT No.: PCT/IB11/51555

§ 371 Date: Oct. 11, 2012

(30) Foreign Application Priority Data
Apr. 12, 2010 (IB) PCT/IB2010/051559

(51) Int. Cl. H04B 7/185

(52) U.S. Cl. 370/316

(57) ABSTRACT

A method for transmitting an encoded aircraft related message comprises receiving an aircraft related text message for encoding, retrieving, based on the aircraft related text message, identity related data being related to the identity of a sender of the message or to the identity of a receiver of the message. The aircraft related text message is processed and an encoded message is generated using a text substitution process which is based on the identity related data. A destination message is derived from the encoded message, the destination message is arranged into at least one data packet, a data signal is generated from the at least one data packet and the data signal is transmitted between an aircraft and a ground based system.

During a flight of an aircraft, communication of messages between the aircraft and a ground station may be either transmitted as voice communications or via text.

Bandwidth on communication satellites for the transmission of text messages can be bought at significantly lower cost when compared to using a system such as the Aircraft Communications Addressing and Reporting System (ACARS). The ACARS network is a digital data-link system used for the transmission of messages between aircraft and ground stations using a telex type format.

A data-link interface may be placed in the cockpit of an aircraft or in another location suitable for interfacing to avionics, like the electronic bay of an aircraft. For example, this type of data-link interface enables messages and information such as a flight plan or weather information to be sent from the airline's ground operations to the cockpit of an aircraft and automatically update the FMS with the new navigation information.

ACARS is also used by airlines to track their aircraft and so provide an information service normally referred to as flight following. In the same way, ACARS is used by pilots to notify the airline and their destination handling agents of any issues requiring attention, for example, a new time of arrival, either early or late, maintenance matters, advance fuel orders, or passenger related special orders.

A network of Remote Ground Stations (RGS) provides a terrestrial system for the reception and transmission of messages to and from the aircraft with the airline operations centre, ATC or with other service providers, such as a fuel agent server, for example. Communications are most commonly conducted via Very High Frequency (VHF) communications, or when aircraft are out of VHF range (generally speaking VHF is a line-of-sight communications medium), via satellite communications or HF data-link. When the aircraft is on the ground, communication can also be carried out via short range WLAN, WIFI, Bluetooth, WIMAX, portable data carrier etc.

The application relates particularly to the transmission of messages between an aircraft and a ground based system.

The application provides a method for transmitting an encoded aircraft related message. The method comprises receiving an aircraft related text message for encoding, for example from an input terminal or a mobile device. Based on the aircraft related text message, identity related data is retrieved which is related to the identity of a sender of the message or to the identity of a receiver of the message.

The sender may refer to one of an aircraft or a ground based system and the receiver to the other one of the aircraft and the ground based system. Identity related data refers to a general information about sender or receiver, for example it can also refer to a characteristic activity of the sender or receiver such as the route of the aircraft, the crew, passengers, or payload of the aircraft etc. The identity related data provides an interpretation context for the message, which is available to the receiver and in general also to the sender of the message and which allows an intelligent text substitution that is based on the identity related data. The identity related data may be stored in a computer readable memory of the aircraft and in a computer readable memory of the ground based system prior to a take-off of the aircraft or it may be exchanged between the aircraft and the ground based system before the message is send from the sender to the receiver, for example by using a radio link.

Furthermore, the method comprises processing the aircraft related text message and generating an encoded message using a text substitution process which is based on the identity related data. A destination message is derived from the encoded message and the destination message is arranged into at least one data packet. In a specific embodiment, the length of the at least one data packet is variable and it does not exceed a pre-defined maximum data length, for example the maximum length of a data packet of a short burst data service. A data signal is generated from the at least one data packet and the data signal is transmitted via an antenna.

The aforementioned method describes a context sensitive encoding. The application also discloses a context sensitive decoding. The context sensitive decoding also works with an encoding process that does not comprise the step of using a text substitution process which is based on the identity related data. The destination message can also just send the identity data together with a text and the identity related data is used on the side of the receiver to complete the message by an information which is retrieved from a database, the retrieval done by using the identity data.

An illustrative example would be the encoding and decoding of the message “LH727 Cptn food 3” meaning that the identity data is “LH727 is a flight from Singapore to Munich”. This means that the Captain wants to order three pieces of a type of food that is typical for Munich, i.e. a Bavarian white sausage. This means that the “LH727 Cptn food 3” can be interpreted “The Captain of LH727 which is approaching Munich orders three Bavarian white sausages after arrival”.

The method may further comprise a step of synchronizing at least part of the identity related information between the sender and the receiver. This step ensures that the information is up to date and the text substitution process on one side matches to the text substitution on the other side. The text substitution process on both sides need not be identical, however.

According to one embodiment, a text substitution process comprises steps of reading in at least one text portion which comprises identity related data. A look-up table is used to look up a code word for the at least one identity related text portion, and the at least one identity related text portion is replaced by the code word. Apart from using keywords, text portions to be substituted may also be identified by a position in a text message, for example in a data table with fixed length data fields or by delimiters, for example in a data table with delimiter separated data fields.

According to a further embodiment, the text substitution process comprises a step of determining a message type of the aircraft related message. If it is determined that the message type is a template, an identity related template is chosen, based on a template number which is contained in the message and based on the identity related data. A template identifier of the template is replaced with an identifier of the identity related template. It is determined if the template comprises parameters and if the template comprises at least one parameter, a look-up table is used to look up a code word for the at least one parameter. This includes the case in which a parameter is not substituted in which case the look-up step does not return a code word. For example, numerical values may be left unencoded. If a code word is found in the look-up table, the at least one parameter is substituted with the code word.

According to a further embodiment, the text substitution process comprises steps of reading in at least one text portion and selecting a look-up table, based on the identity related data. A code word is looked up for the at least one text portion in a look-up table and the at least one text portion is replaced by the code word.

In a special embodiment, the transmission method comprises a generation of one or more short burst data signals from the data packets. In this embodiment, the data packets have a variable length which is shorter or equal to a maximum length of a short burst data message. If the total length of all data packets is not a multiple of the maximum length, than, in a typical example, the last data packet will have a length that is shorter than the maximum length. For other transmission methods, such as Bluetooth, TCP-IP, the packet sizes may also be equal and the length of the packets will depend on the transmission method. In general the chosen packet size will also depend on cost, overhead and reliability.

In another embodiment, a priority is assigned to the aircraft related message and, based on the priority, a condition is determined for sending the aircraft related message. It is furthermore determined if the condition for sending the aircraft related message is fulfilled. If the condition for sending the aircraft related message is fulfilled, the destination message is transmitted via a radio link or via a data carrier, such as USB stick, DVD etc. For transmission via radio link, the message is arranged into at least one data packet, a data signal is generated from the at least one data packet and the data signal is transmitted via an antenna.

For example, the condition for sending the aircraft related message comprises determining an actual position of the aircraft. Based on the actual position of the aircraft, a location and a transmission method for the aircraft based message is determined. In other examples the condition may depend on a severity of an error condition of a machine part, on the type of a message and so forth.

By way of example, a message type dependent priority grading is provided by the following message handling table:

| priority flags | CMP | CMP Level | ENC | ENC Level | CHK | SIG | Priority | Latency | Cost |
|---|---|---|---|---|---|---|---|---|---|
| value range | 0: NO | 0: NONE | 0: NO | 0: NONE | 0: NO | 0: NO | 0: H | 0: lmm | 0: SBD |
| | 1: YES | 1: META | 1: YES | 1: SYMM | 1: CRC32 | 1: YES | 1: M | 1: 1 hour | 1: SBD, |
| | | 2: META, LZO | | 2: PKI | 2: SHA1 | | 2: A | 2: aft ldg | RUDICS |
| | | 3: LZO, ZIP | | | | | 3: L | 3: w arch | 2: RUDICS, |
| | | 4: LZO | | | | | | | BLTOOTH |
| | | | | | | | | | 3: USB, |
| | | | | | | | | | BLTOOTH |
| Message Types | | | | | | | | | |
| Mission Data | 1 | 4 | 1 | 1 | 0 | 1 | 0 | 1 | 2 |
| Load Sheet | 0 | 0 | 1 | 2 | 0 | 1 | 1 | 3 | 3 |
| Fuel Order | 0 | 0 | 1 | 2 | 0 | 1 | 1 | 2 | 3 |
| WX | 1 | 1 | 0 | 0 | 1 | 0 | 2 | 1 | 0 |
| NOTAM | 1 | 1 | 0 | 0 | 1 | 0 | 2 | 1 | 0 |
| Wind | 1 | 1 | 0 | 0 | 1 | 0 | 2 | 1 | 0 |
| Flight Following | 1 | 1 | 1 | 1 | 1 | 0 | 0 | 0 | 1 |
| SMS | 1 | 2 | 0 | 0 | 1 | 0 | 3 | 1 | 2 |
| Email | 1 | 2 | 1 | 2 | 1 | 1 | 3 | 1 | 2 |
| Emergency Files | 1 | 3 | 1 | 2 | 1 | 1 | 0 | 0 | 1 |

Herein, CMP specifies a compression, CMP level a compression level, ENC an encryption, ENC level an encryption level, CHK a checksum or hash value. A mode of sending the message is determined by the last three parameters priority, latency and cost. The message handling table is stored in a computer readable memory on the aircraft and on the ground based system. The values in the message handling table on the aircraft may be different from the values of the message handling table in the ground based system, for example due to a difference in price structure between sending aircraft to ground messages and sending ground to aircraft messages via a satellite network.

Again by way of example, flag values are provided for the priority flags of the message handling table. These flag values can be set by a user of the flight information system to control message handling and/or the cost of sending messages.

In the given example, the compression may be none, meta-code text substitution, meta-code text substitution and LempelZiv-Oberhumer (LZO) combined, ZIP with LZO compression and LZO compression alone. The meta code substitution is based on a message structure that is known to both the sender and the recipient. This message structure can be stored in advance, as in the case of the NOTAM message structure, or updated dynamically between aircraft and ground based system, as in the case of the word frequency dependent coding. The meta code substitution may be combined with other compression algorithms such as LZO, LZMA or others to obtain an even higher compression. The compression algorithms may also be used instead of the meta-code, for example for free text messages. Lossless compression algorithms other than LZO, LZMA may also be used for the text based messages. If image and sound data are to be transmitted as well, lossy compression algorithms such as MPEG, JPEG may be used for those data.

Furthermore, confidentiality and message integrity may be provided by encryption and checksums. In the given example, symmetric encryption such as AES, DES etc. and public key based encryption such as RSA etc. are provided for encryption and CRC32 and SHA1 are provided as checksums. Other checksums may be used as well, such as MD5. In order to reduce message length, the asymmetric PKI encryption may be applied to a session key which is transmitted with the message and which is in turn used for a symmetric encryption of other parts of the message.

Moreover, the abovementioned message handling table specifies message priority gradings high, medium, average and low, message latency gradings of immediate, within 1 hour, after the next landing and together with an archive that is synchronized in regular intervals between the aircraft and the ground based system. Transmission on the ground provides the lowest cost but may imply a longer latency. Typically, the lowest latency grades are attributed to data which is associated with the flight planning at the beginning of a mission, such as the load sheet and mission data. The time latency may also be more or less than one hour or there may be several time latency values.

In the given example, the cost flag determines directly the transmission method. The transmission methods specified by the cost flag are, by way of example, SBD, RUDICS and Bluetooth. SBD stands for a data transmission with variable length data packets wherein the cost depends on the length of the data packets. RUDICS stands for a data transmission which is circuit switched and wherein the cost depends on the transmission time. Bluetooth stands for a short range WLAN data transmission, which may be used when the aircraft is on the ground. In another embodiment, the transmission method may be chosen dynamically based on the cost flag, determined by latency rules and the desire to minimize actual transmission cost.

The message handling table defines a pre-determined and adjustable priority system for the transmission of messages between the ground based system and the aircraft based system and between the aircraft based system and the ground based system. The application of the pre-determined message priorities may also be realised by a distribution logic that is able to determine, by reference to other aircraft systems, for example a GPS unit, the location of the aircraft at a particular point along the flight. Depending on the position of the aircraft in relation to the overall flight route, the distribution logic may, for example, delay sending a message until an aircraft is on the ground and make use of a Bluetooth connection at the arrival gate in preference to using a most costly satellite connection.

The pre-determined priority system may be configured to recognise certain types of messages which have a higher priority than others, for example those relating to the safety of the flight, or to the movement of connecting passengers when delays to a connecting flight will introduce additional costs to the operating airline.

A customer, user or internal administrator can define the routing rules and priority settings in use, for example by the abovementioned message handling table. In a typical embodiment according to the application, the customers or users have access to the ground-based system where they can access the rules to apply to a particular aircraft type, flight number, city pair, aircraft serial number, pilot qualifications etc. In this particular example of an embodiment according to the application, the routing rules which are applied can relate to aspects such as the maximum delay time for certain messages being expressed as x hours and y minutes or other definable parameter settings, or that certain types of messages are to be send only when the aircraft is on the ground. Further parameter settings can define other than normal routing conditions, for example if a certain warning or exceedance value has occurred a certain number of times, then the message must be sent immediately.

A message handling table can be provided in a memory of the ground based system. Users may adjust the message handling table from time to time according to their preferences. Furthermore, it is stored to which aircraft the message handling table applies. The message handling table is transferred to the respective aircrafts, e.g. to all fleet of an airline. In a more detailed embodiment, a date and time information is transmitted along with the message handling table which specifies from which time on the changes to the message handling time are to be made effective.

According to the application, an algorithm may be provided such that a packet size of transmitted data is selected based on a chosen transmission method such as short burst, switched circuit etc. A further algorithm may be provided to select a most efficient encoding method based on a message type or type of data handled.

According to a further aspect, the application discloses a message filter for selective sending of a message from a ground station to an aircraft. The message filter further reduces the amount of message traffic. A plurality of aircraft related messages is stored in a message cache at the ground station. The messages are evaluated for the relevance to a particular aircraft on a particular flight mission. The relevance criteria comprise the flight route and the current position of the plane. According to one embodiment of the message filter, messages which relate to waypoints, airports or other geographic location that are either too far away from the flight route or which lie too far behind relative to an estimated current position of the aircraft on the flight route are not sent to the aircraft. The message filter may also take into account a list of alternative airports which is updated based on the estimated current position of the aircraft. This assures that messages relating to alternative airports are always sent. The message filter may furthermore specify a relevant range around the flight route by a predetermined lateral distance from the flight route.

Furthermore, the application discloses a method for decoding an encoded aircraft related message. The method comprises receiving at least one data signal, deriving at least one data packet from the at least one data signal and arranging the at least one data packet into an encoded aircraft related message. In a specific embodiment, the at least one data packet has a variable data length which is shorter than a maximum data length. for example a maximum length of a short burst data message. The aircraft related message is forwarded to a data processing unit and at least one code word is extracted from the aircraft related message.

Based on the code word or the code words, and, in some cases, also further identifiers, identity related data is retrieved. The aircraft related text message is processed and an encoded message is generated using a text substitution process which is based on the identity related data. The decoded message is outputted to an output destination.

In one embodiment, the step of retrieving the identity based information comprises selecting a look-up table based on an identifier which is included in the aircraft related message and retrieving the identity based information, based on the selected lookup-table and the at least one code word.

In a further embodiment, the step of retrieving the identity based information comprises retrieving a data reference from a look-up table and of retrieving, based on the data reference, the identity related data. In this way, identity related data which is stored at the receiver does not need to be duplicated in the lookup-table. For some information, which is retrieved during the flight, the replaced text may also not be available at the time when the lookup table is generated or updated but at the time of generating the message. This requires, however, that the receiving side has an independent means for accessing that information.

According to the application, a transmitter device is disclosed which comprises a reception unit for receiving an aircraft related text message for encoding and a processing unit for retrieving, based on the aircraft related text message, identity related data being related to the identity of a sender of the message or to the identity of a receiver of the message from a database, for processing the aircraft related text message, for generating an encoded message using a text substitution process which is based on the identity related data, and for deriving a destination message from the encoded message, wherein the processing unit further arranges the destination message into at least one data packet. The receiver device furthermore comprises a communication unit for generating a data signal from the at least one data packet and for transmitting the data signal via an antenna.

Furthermore, a receiver device for decoding an encoded aircraft related message is disclosed which comprises a communication unit for receiving at least one data signal and for deriving at least one data packet from the at least one data signal and a processing unit for arranging the at least one data packet into an encoded aircraft related message and for extracting at least one code word from the aircraft related message and retrieving from a database identity related data based on the at least one code word (and possible on further identifiers), and for processing the aircraft related text message and generating an encoded message using a text substitution process which is based on the identity related data. Furthermore the receiver device comprises an output unit for outputting the decoded message to an output interface, such as an interface to a storage device, a message forwarding device, a display device etc.

The application also discloses a communication link with a receiver device and a sender device according to the application and furthermore an aircraft with a receiver device according to the application and an aircraft with a sender device according to the application.

Furthermore, a ground based system with a sender and/or a receiver according to the application is disclosed.

The subject of the application also comprises the below mentioned methods and the corresponding message transmission devices.

A method for transmitting an uplink message from a ground based system to an aircraft or for transmitting a downlink message from an aircraft to a ground based system. An aircraft related text message is received for encoding and a a message data type is determined, wherein the type belongs to a predetermined set of data types, for example TAF, NOTAM and other standardized aeronautic messages as well as free text and predefined and user defined standardized messages. According to the application, the message data type provides an interpretation context which allows a more effective data reduction of transmitted messages.

Furthermore, identity related data which is related to the identity of a sender of the message or to the identity of a recipient of the message is retrieved. The identity data may be essentially unchanging such as an aircraft tail number or also dynamic as for example a mission or a session of an aircraft. According to the application, the identity data, too, provides an interpretation context that allows an effective data reduction.

Meta codes are retrieved from a look-up table, also known as substitution dictionary, wherein the meta codes of the look-up table are dependent on the message data type and on the identity related data. Words or group of words in the message are replaced by entries of the look-up table to obtain an encoded message. Words in this sense are groups of Bits or characters which have a predefined meaning and which can be uniquely identified, for example, by delimiters or by a relative position in a data stream. Preferentially, messages are shortened by the replacement, at least on average.

The encoded message is then transmitted by deriving a destination message from the encoded message, arranging the destination message into at least one data packet generating a data signal from the destination message or from a data package of the destination message and transmitting the data signal via an antenna or, if the aircraft is on the ground, via a portable data medium such as USB-stick, CD, DVD.

Specifically, the identity related data may relate to an airline code, an aircraft tail number, an aircraft rotation schedule, an aircraft route, a session data or even a multi-session data, wherein the multi-session data comprises previous session data and previously sent messages. Beginning and end of a session may be defined, for example, by data trans-fers when the aircraft is on the ground. The session data and multi-session data allow to identify characteristic message patterns and word frequencies which in turn provide for an effective text substitution. A means for determining a word frequency may comprise a parser which generates a weighted binary tree, for example.

In a specific embodiment, the method also comprises storing of transmitted messages in a message cache of a memory and deriving word frequencies of a word from the transmitted messages in the message cache. Meta codes are attributed to words based on the word frequencies and the meta codes are stored in the lookup table. By allocating shorter codes to more frequent words, an amount of transmitted data is reduced.

According to the application, the amount of transmitted data can also be reduced by storing transmitted messages in a message cache of a memory at a sender side and identifying previously sent messages of a message thread in a message to be sent using the message cache at the sender side. The previously sent messages of the message thread are then replaced by message identifiers prior to transmitting the message. On the receiver side, a corresponding message cache is used to replace the message identifiers by the thread messages again.

The method may furthermore comprise identifying a template and identifying a word or text block that represents a numeric value. The template is replaced with a template identifier and the template identifier and the numeric value are included in the message to be sent.

According to the application, a message size may be reduced even further by encoding numeric values such as wind speeds, height levels etc. Specifically, this may comprise retrieving a numeric value from a message to be sent, converting the numeric value into a hexadecimal value and including a text portion or word which represents the hexadecimal value into the message. The 16 different hexadecimal values may be represented by 15 different characters. In a more general sense, a b-adic representation may be used where b is greater than 10 and smaller than the number of available characters of a character alphabet being used, wherein characters also comprise numbers, non-printable characters etc.

Alternatively or in addition, a binary encoding may be used. Therein, a numeric value is retrieved from a message to be sent and the numeric value into a binary representation. To align the bit representation with a character alphabet, additional bits are added to the binary representation such that a total number of bits is a multiple of a number of character bits to obtain an encoded value and the encoded value is included in the message.

Furthermore, a number of transmitted bits can be effectively reduced by transmitting delta message. Therein, a numerical data field is identified in a message to be sent which is formatted according to a predetermined message format. A first numeric value from the numerical data field in the message to be sent. A second numeric value of the same data field is retrieved from a previously sent message which is stored in a computer readable memory. A difference between the first numeric value and the second numeric value is computed, the difference is encoded by using ciphers of the character set, or binary or b-adic or otherwise, and the encoded difference is included in a message to be sent which is then transmitted, either from aircraft to ground based system or from ground based system to aircraft.

Furthermore, according to the application, a numeric value may be omitted altogether from a message if the recipient is able to deduce its value from other parts of the message, from previously sent messages or otherwise. Specifically, this may comprise retrieving a first numeric value from a previously sent message and retrieving a second numeric value from a message to be sent. The first numeric value is compared with the second numeric value. If the first numeric value is equal to the second numeric value a data field that corresponds to the second numeric value is removed from the message to be sent.

According to the application, a message counter may be included into the message. In this way it can be ensured that the delta messages are always decodable. Specifically, a a message counter is included into a message to be sent on a sender side. On receipt of the message at a recipient the message counter is compared with a previously received message counter. If it is detected, based on the comparison, that a lost message has not been send a resending of the lost message is requested and decoding of a message is delayed until the lost message has been received. This applies especially if the lost message comprises a data field which is not included in the message or wherein the message comprises a data field with a value that is dependent of the value of the same data field in the lost message.

In a more general sense, removing redundant information in a message according to the application comprises determining a message type of the aircraft related message by parsing or from inspecting a message header, identifying a redundant word or group of characters that represents a redundant information in the message, especially relating to a data field in the message and removing the redundant information from the message to be sent. The redundant word may relate to some previously transmitted information, especially in a message of the same type or a redundant information which is already present in the same message.

In a further aspect according to the application, graphical weather data is transmitted in a text form, which allows to reduce a message size. Therein, a path in a weather chart is identified, for example by edge recognition or reading out a user input. The path is approximated by straight line segments and the endpoints of the straight line segments are represented by a plurality of coordinate values. A means to obtain the coordinate value may comprise a computer program. The coordinate values are included in the message to be sent. A means for including coordinate values or other data in a message may be provided by a device for writing to a data stream and a controller for this device.

Specifically, the path may represent a wind trajectory, for example a jet stream. In this case a wind vector which is associated to one of the straight line segments is identified and magnitude and direction of the wind vector are determined. Magnitude and direction of the wind vector to are encoded to obtain encoded wind data which is included into the message to be sent. The path may furthermore represent a closed boundary of a weather region, such as clouds, clear air turbulence, sandstorms etc. The coordinates can also be encoded as relative coordinates to obtain a further reduction in message size. Accordingly, a relative coordinate is obtained by forming a difference between and endpoint of one of the straight line segments and a geographic location and the relative coordinate is included into the message to be sent.

According to a further aspect, the application discloses a method for choosing a transmission method between an aircraft and a ground station. According to this method, a latency identifier is retrieved from a message header. The latency identifier is evaluated. If the latency identifier specifies immediate the message is sent within a predefined maximum time limit inasmuch as the availability of a data connection allows it. If the latency identifier specifies a time limit, messages to be sent are collected in an aircraft based memory and the collected messages are sent before the specified time limit expires. The latency identifier may also specify sending after landed in which case messages with the latency identifier “after landed” are collected and at the next stay at an airport the collected messages are transmitted to a ground station via an antenna or via a portable data carrier. The latency identifier may furthermore specify transmission with a data archive in which case messages with the latency identifier “with archive” are collected and the collected messages are transmitted at a predetermined time of exchanging an archive. This takes place typically during a stay of the aircraft at an airport.

The amount of data traffic may be further reduced by filtering out relevant aeronautic message to be sent to an aircraft. Therein, an aircraft position is determined by position feedbacks and trajectory simulation. A relevance of a message to be sent is determined, based on the aircraft position. If the message to be sent is determined as relevant to an aircraft on a specific mission, the message to is sent to the aircraft. If the message to be sent is determined to be not relevant, the message is discarded.

Specifically, this may imply determining a geographical range of the message and comparing the geographical range with predetermined regions around present and future locations of the plane on a predetermined flight path. If the geographical range of the message falls within the regions around present and future positions the message is determined to be relevant. Otherwise the message may be checked for further relevance criteria and be determined as not relevant if those criteria are not met. Furthermore, this may also imply comparing the geographical range of the message with regions around a list of alternative airports which depends on the current position of the plane and, if the geographical range of the message falls within the regions around the alternative airports, the message is determined as relevant.

Furthermore, the application discloses methods for updating a substitution dictionary or lookup table at an aircraft and for updating a substitution dictionary or lookup table at a ground based system.

According to the first method, identity related data, for example a flight route, is received from a ground based system. Further data may also be received, such as word frequencies. A substitution list with words and associated meta-codes based on the identity related data, either on the ground or in the aircraft. The identity related data and the substitution list is stored in an aircraft based database. A previous substitution list is thereby replaced.

According to the second method, a substitution list with words and associated meta-codes is retrieved from an aircraft based memory and the code list with words and associated meta-codes is transferred to a database in a ground station, by radio link such as short range WLAN or by portable data carrier. A previous substitution list is replaced.

The subject matter of the application is now explained in further detail with reference to the following Figures, in which

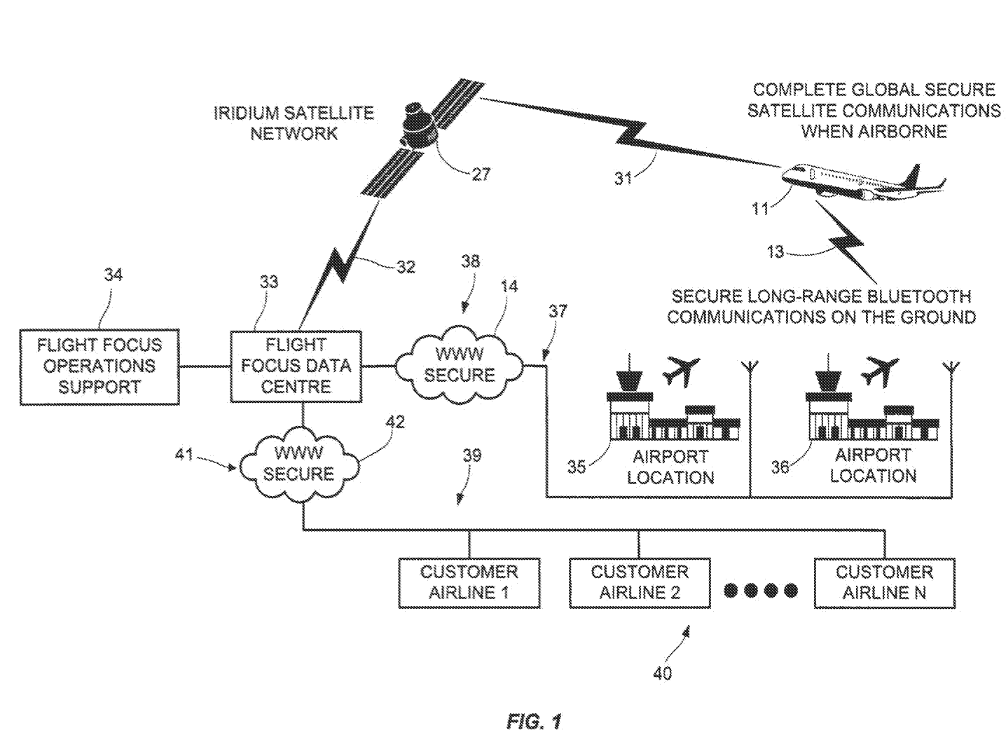

FIG. 1 illustrates an operational diagram of a flight information system,

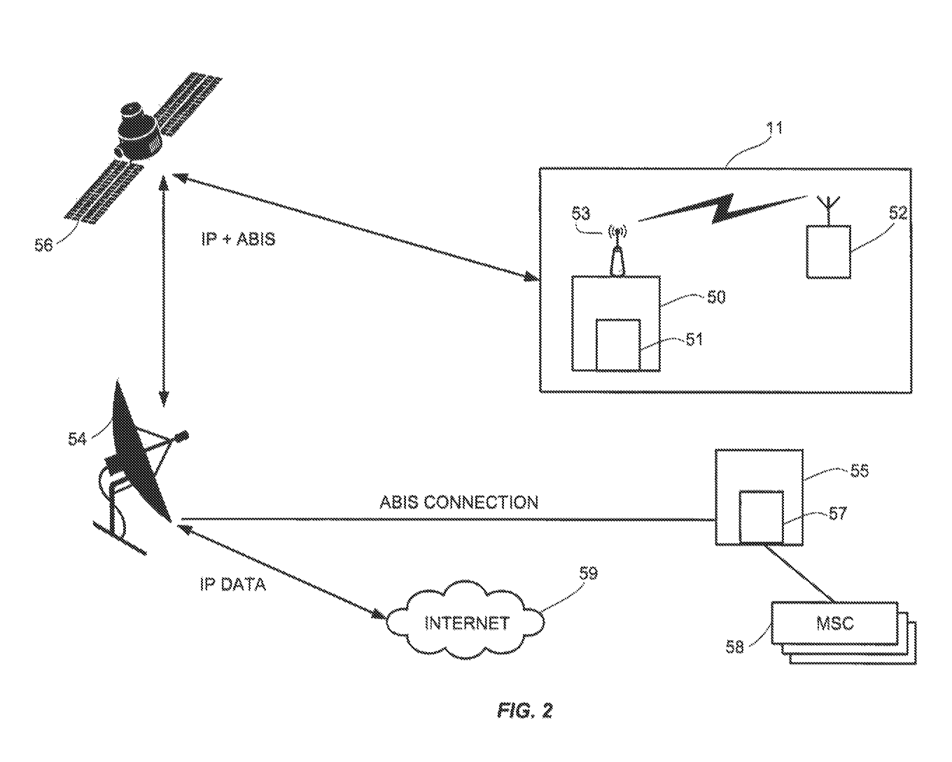

FIG. 2 illustrates an arrangement for voice call and data package transmission,

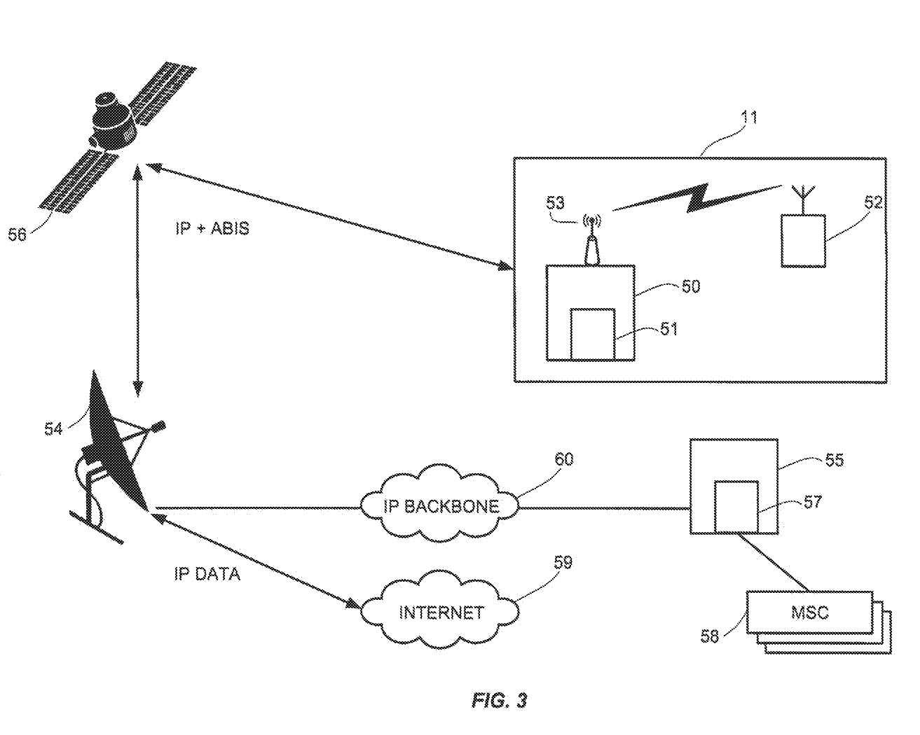

FIG. 3 illustrates a second arrangement for voice call and data package transmission,

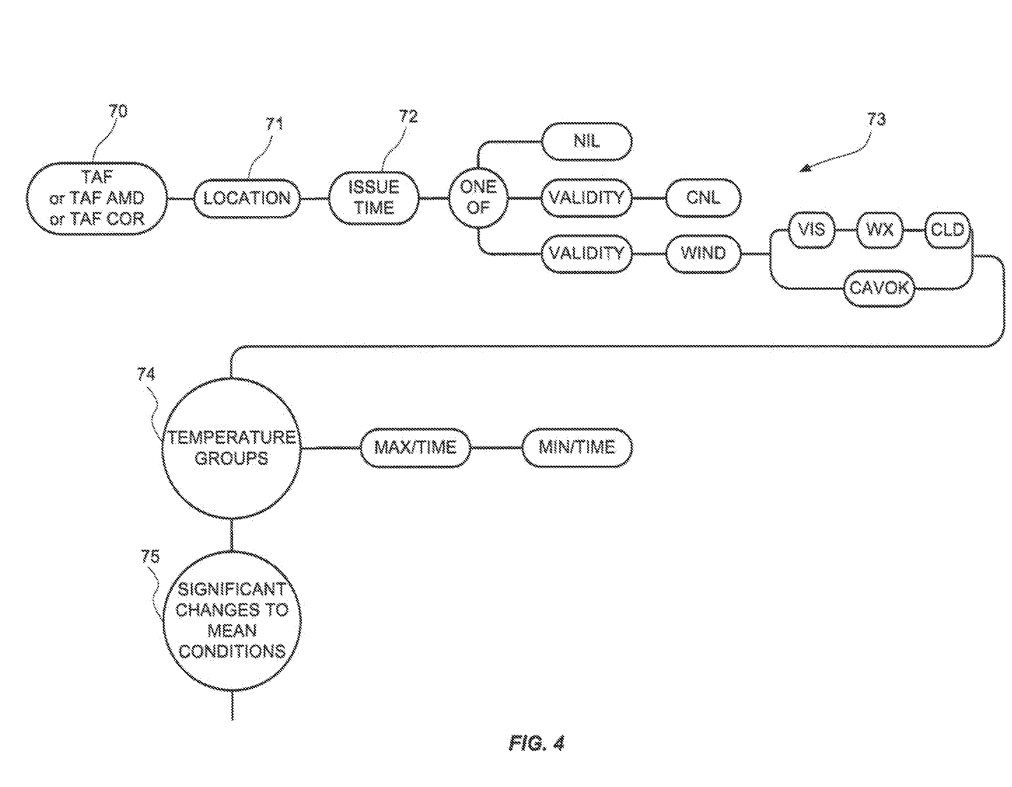

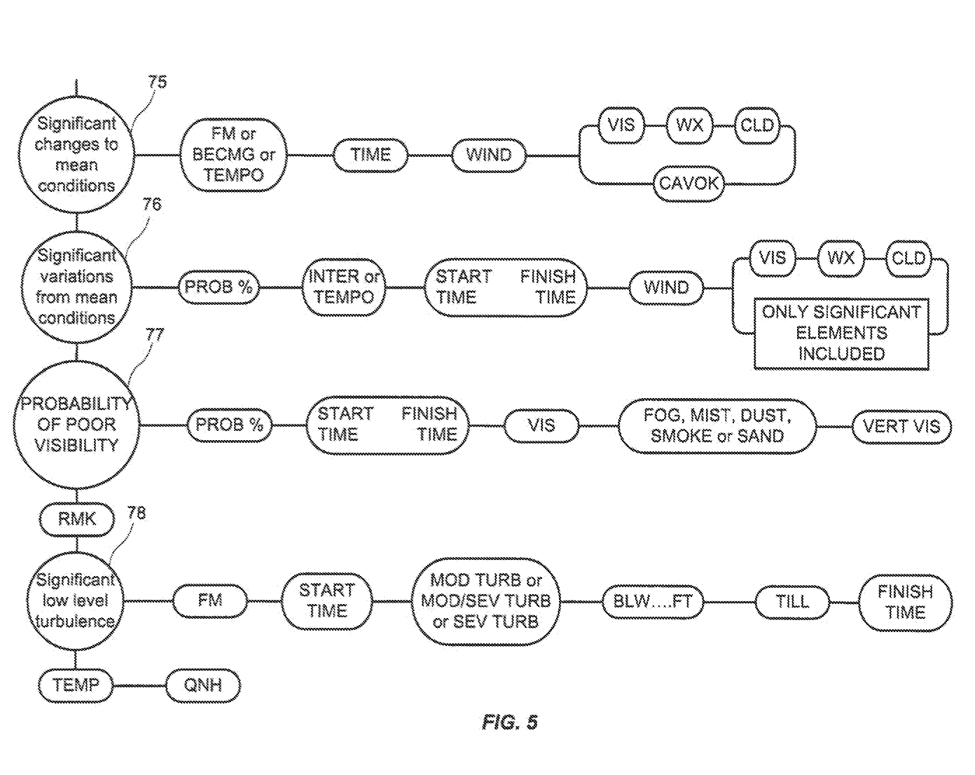

FIGS. 4 and 5 illustrate a parsing diagram for METAR messages,

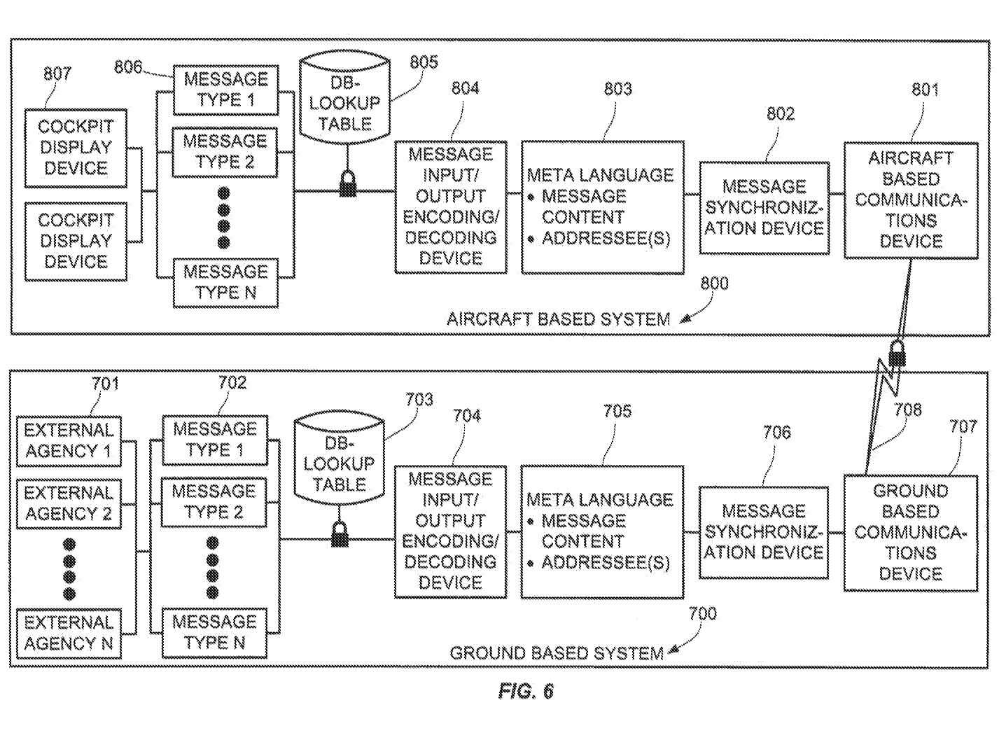

FIG. 6 illustrates a process flow relating to the exchange of messages between a ground-based system and an aircraft-based system, and

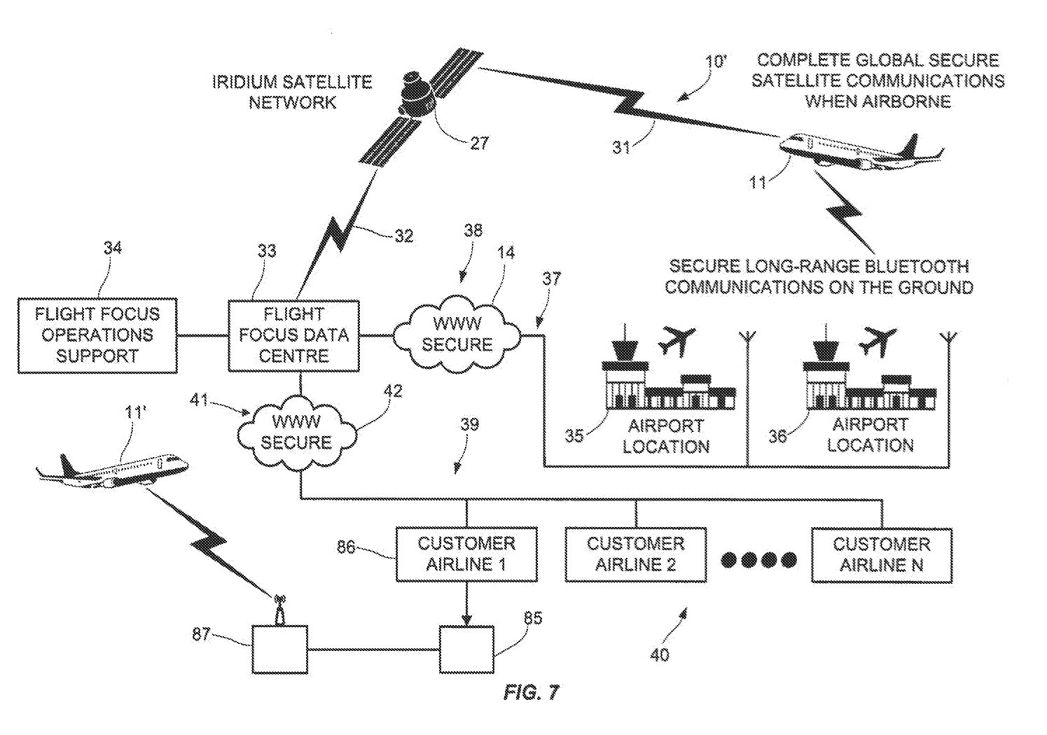

FIG. 7 shows an alternative embodiment of a flight information system,

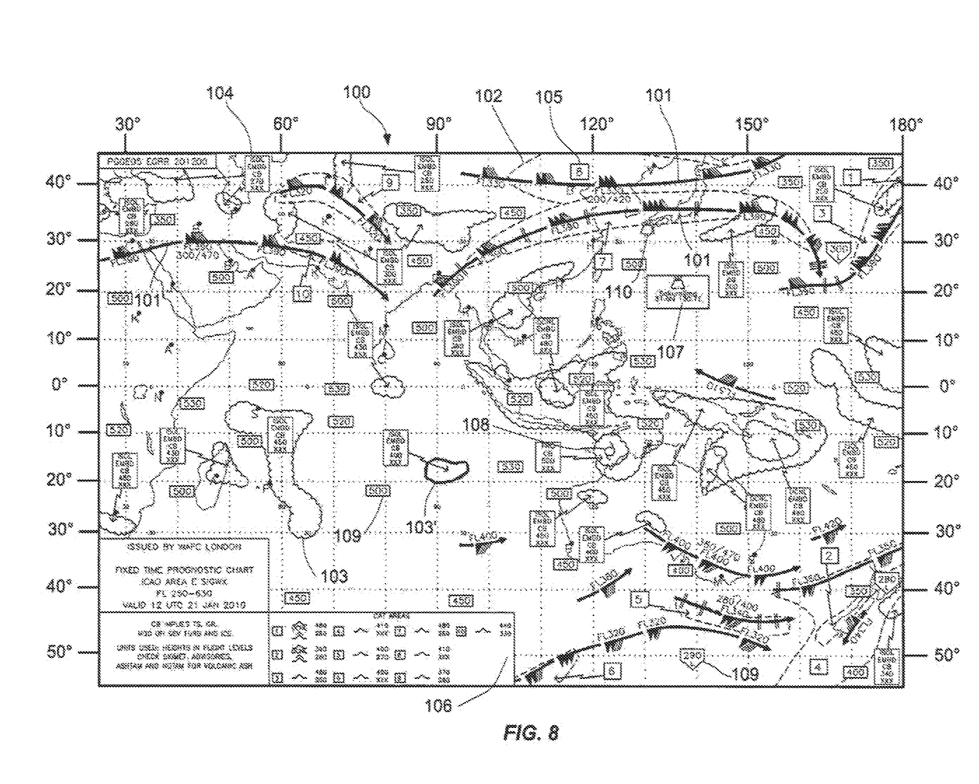

FIG. 8 illustrates information extraction from a significant weather chart,

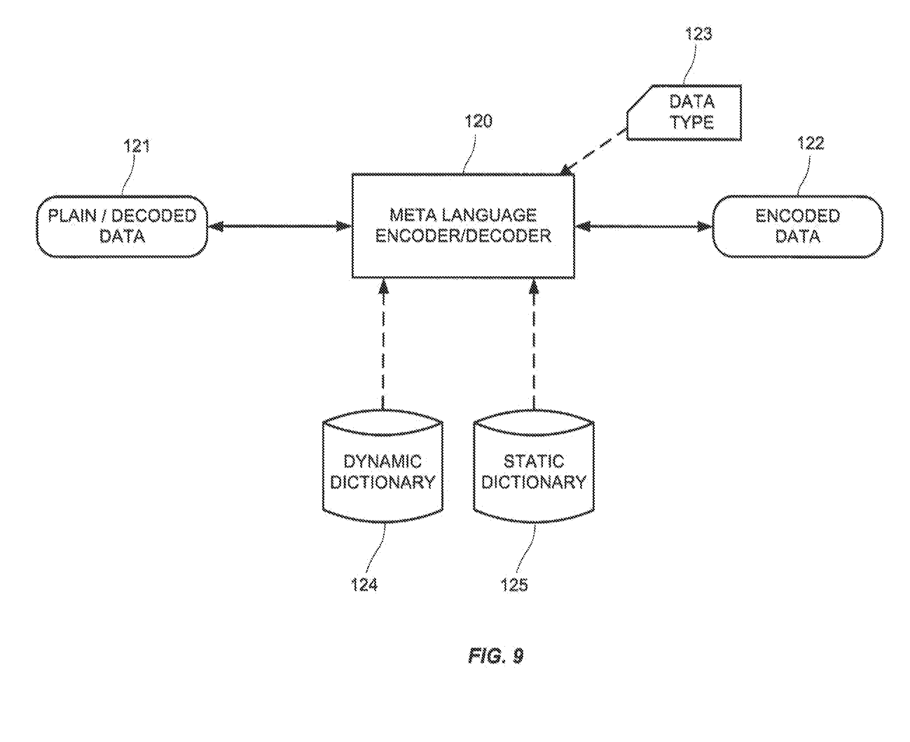

FIG. 9 illustrates a meta language decoder/encoder,

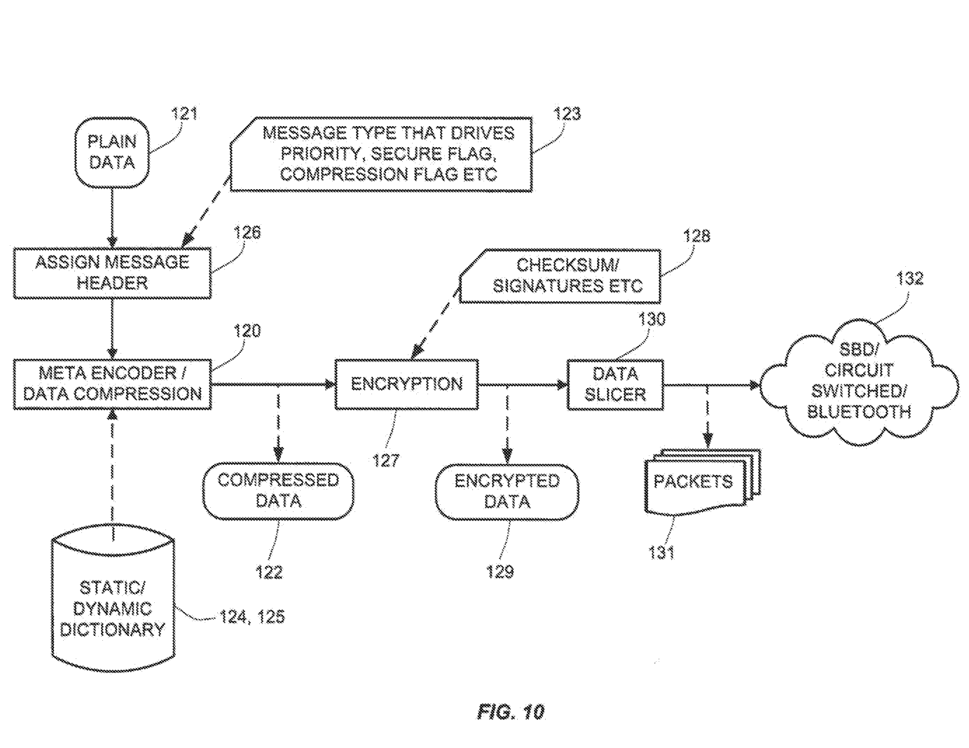

FIG. 10 illustrates a message encoding using the meta encoder,

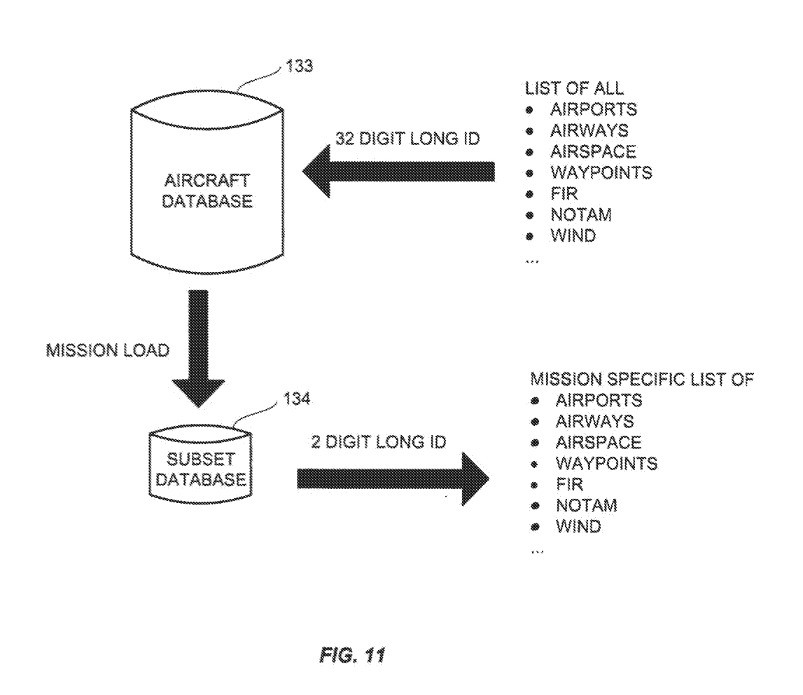

FIG. 11 shows an aircraft database and an aircraft based subset database,

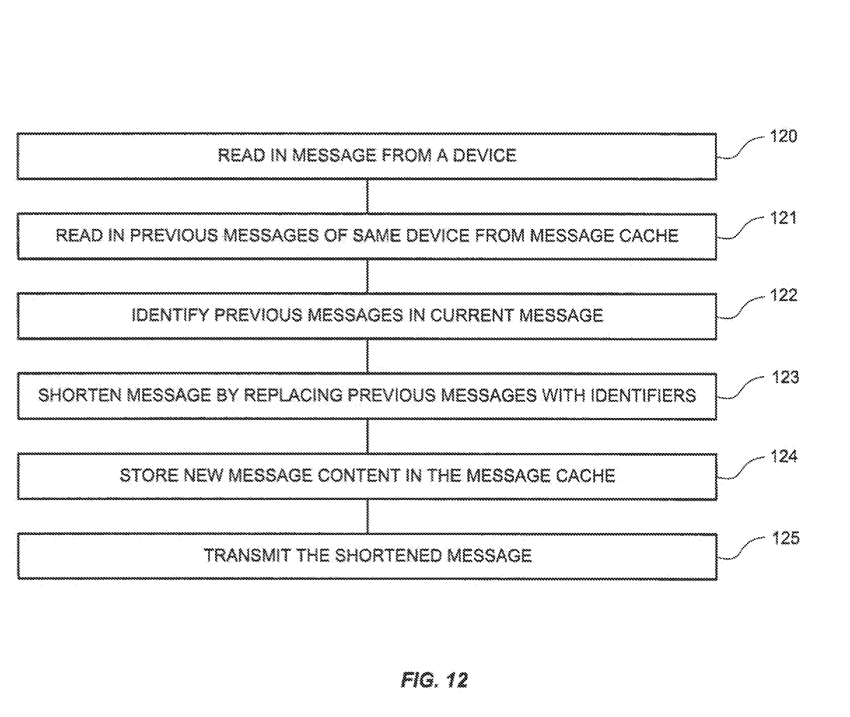

FIG. 12 shows a text substitution based on thread identification, and

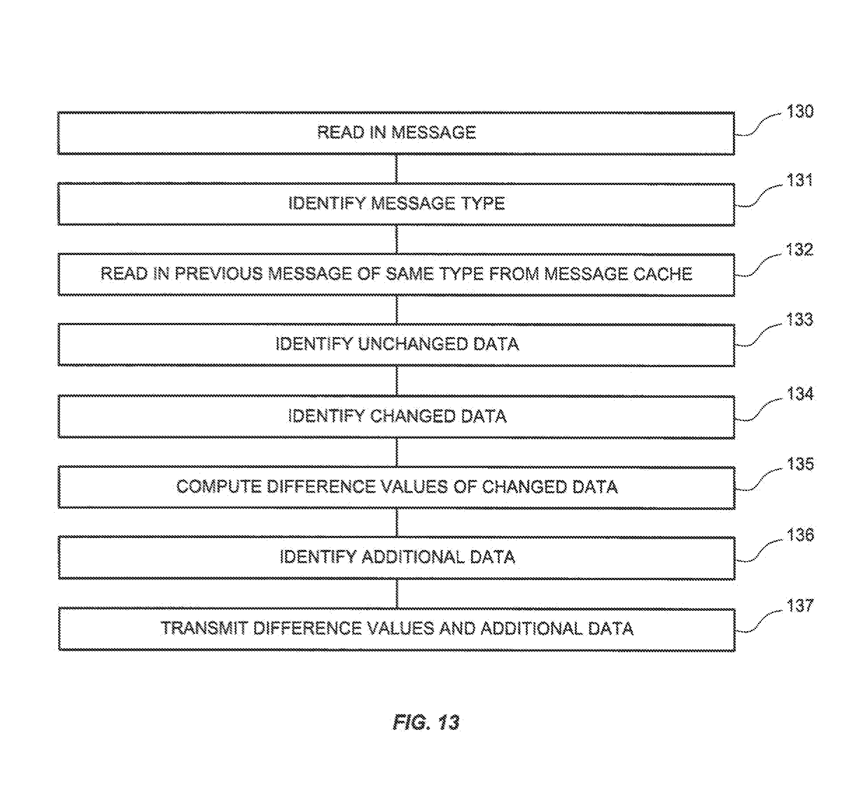

FIG. 13 shows a generation of a delta message.

In the following description, details are provided to describe the embodiments of the application. It shall be apparent to one skilled in the art, however, that the embodiments may be practised without such details.

In the following, messages to an aircraft will be referred to as “incoming messages” and messages from the aircraft will be referred to as “outgoing messages”.

FIG. 1 shows an operational diagram of a flight information system 10.

The flight information system 10 comprises airborne components of the flight information system which are provided on the aircraft 11. The airborne components include, among others, one or more displays, a main computer, means for communication and data exchange and on board applications and data which are stored on a computer readable medium.

A first portion 31 of a satellite communication channel connects the airborne components of the flight information system 10 to the satellite 27. A second portion 32 of the satellite communication channel is provided between a service provider's data centre 33 and the satellite 27. The connection between the service provider's data centre 33 and the satellite 27 may involve intermediate nodes, for example of an aeronautical telecommunication network, which are not shown in FIG. 1.

The service provider's data centre 33 is connected to an operations support centre 34. Airport communication channels 37 are provided between the service provider's data centre 33 and airports 35, 36. The airport communication channels 37 comprise a first secure connection 38 via a first data network 14. Airline communication channels 39 are provided between the service provider's data centre 33 and airline offices 40. The airline communication channels 39 comprise a second secure connection 41 via a second data network 42.

Furthermore, a Bluetooth communication channel 13 is provided between a transmitter at an airport 35, 36 and the aircraft 11. The Bluetooth communication channel 13 serves to connect the aircraft 11 to the service provider's data centre 33 via the airport communication channel 37 while the aircraft 11 is on ground.

FIG. 6 shows an arrangement for the receipt and transmissions of messages between a ground based system and an aircraft-based system. The ground based and the aircraft based systems comprise computerized means for storing and processing data and means for receiving and transmitting data. The ground-based system 700 receives messages from external agencies 701, and these messages may be different message types 702 and in different message formats. As the messages come into the ground-based system 700 they are analysed by an input/output encoding/decoding device 704 which is connected to a database 703 containing a lookup table. After the message has been encoded (or decoded if the message is outgoing from the aircraft to external agencies), using the meta language lookup table, the message is examined to determine its address 705, passed to a message synchronisation device 706 which ensures that all messages held on the ground-based system are passed to the aircraft-based system 800, passed in turn to a ground-based communications device 707 which determines the most appropriate transmission path for the message to the aircraft 11 using either a secure Bluetooth connection 13 from an airport 35 and 36, or via communications connections 32 and 31 via satellite 27. The process at 704 also includes additional steps for compression and decompression, calculation and verification of checksums, and signature processing and verification.

When the aircraft 11 receives a message via the secure, encrypted communications channel 708 in an aircraft-based communications device 800, the message is passed to the aircraft-based message synchronisation device 802 which in turn checks that the message is in the correct numbering sequence, or if a message in the sequence is missing, for example the message sequence received is message 1, message 2, message 4, then the message synchronisation device will request message 3 from the ground-based system 700 to ensure all messages are correctly received. This process is reversed in the case of outgoing messages from an aircraft to a ground-based system.

The message is passed from the message synchronisation device 802 to examine the content in process 803 and then passed to the message input/output decoding/encoding device 804 which calls on a lookup table 805 to take the coded message into one of the message types 806 for display in an appropriate part of the aircraft-based system's cockpit display device 807, and depending on the type of message, software associated with the messaging system provides an aural alert, or visual alert using LED on the front panel of the cockpit display device 807. The LED and the precise operation of the LED are not shown in this figure. Alternatively, messages may be passed to other portable electronic devices such as mobile telephones, personal computers etc onboard the aircraft if they are determined by the examination process in 802 as having a mobile telephone address. The process at 804 also includes additional steps for compression and decompression, calculation and verification of checksums, and signature processing and verification.

In this latter case, that of passenger related messages or information, FIGS. 2 and 3 show an arrangement for transmitting text and voice messages between a mobile terminal device in an aircraft 11 and a ground station. The ground station is connected to a network and to a GSM (global system for mobile communications) network.

A BTS (base transceiver station) 50 is provided within the aircraft 11. Mobile terminal devices 52 on board of the aircraft 11 are connectable to the BTS 50 via an antenna 53 of the BTS 50. The BTS comprises a switching module 51 which is connected a transceiver on the aircraft 11, which is not shown. The switching module 51 comprises an Abis emulator that is not shown which emulates the Abis protocol with respect to the mobile terminal unit 52. Furthermore, the BTS 50 is connected to the main computer via a connection cable. The main computer comprises a text processing unit for modifying, inserting and replacing text of a data message.

On the ground, an antenna 54 of a BSC (base station controller) 55 is connectable to the antenna of the aircraft 11 via a satellite communication link that comprises one or more satellites 56, such as, for example a geostationary satellite or one or more satellites of a global satellite network. The BSC 55 comprises a switching unit 57. The switching unit 57 comprises an Abis emulator which is connected to MSCs (mobile services switching centres) 58. Furthermore, the BSC 55 is connected to a network 59, such as the internet.

In the alternative embodiment of FIG. 3, the BSC 55 is connected to the antenna 54 of the ground station via an IP backbone 60.

During a flight of the aircraft 11, the mobile terminal devices of the flight passengers send outgoing data messages to the base station controller of the aircraft. Likewise, airborne components of the flight information system transmit outgoing data messages to the base station controller. A data transformation unit transforms the outgoing data messages into processed data messages. The processed data messages are segmented into data packages and the data packages are transmitted to a satellite or via a Bluetooth connection if the aircraft is on the ground. The satellite transmits the processed data packages to a ground station, either directly or via further satellites, while the Bluetooth connects with the service provider's data centre. The data packages have a predetermined maximum size. Specifically in the case of a short burst data service, the maximum length of a data packet is determined by the predetermined maximum length of a SBD message.

The service provider's data centre receives incoming data messages which are destined for an aircraft 11. The incoming data messages comprises operational type messages which are destined for the flight crew, such as NOTAM and weather data, and other non-operational messages which are addressed to passengers on board the aircraft 11 such as SMS, voice data, WAP pages and other internet content. A data transformation unit of a computer at the service provider's data centre transforms the incoming data messages into processed data messages. The processed data messages are transmitted to a satellite. The transmission is carried out either directly via a transmitter or via an intermediate network such as a telephone network or the internet and via a transmitter. The satellite transmits the processed data messages to the aircraft 11, either directly or via further satellites.

In a special embodiment according to the application, a short burst data service (SBD) of a global satellite provider is used. Specially adapted modems are used for sending and receiving short burst data. The SBD restricts the payload of a message to a certain length, for example less than 10 kilobytes, less than 2 or less than 1 kilobytes at a time.

The messages may be converted to be delivered in a specific format such as an email format and may be sent via HTTP to a preconfigured address. The payload size of data bursts is a compromise between reliability and efficiency. If the length of the data bursts is smaller, reliability is increased and the messages are less prone to disturbances. On the other hand, the overhead relative to a given payload increases with decreasing message size. If the length of a message exceeds the maximum payload size, the message is segmented at the sender side and reassembled at the receiving side.

An ingoing e-mail is formatted in a predetermined format, for example, the e-mails include a destination ID in the message body and a message text in a mail attachment. The service provider's data centre 33 sends the ingoing e-mail via internet or a public switched telephone network (PSTN) to a data centre of the satellite provider. In the case of the SMTP protocol, the address of the satellite provider's data centre is taken from an SMTP protocol message. At the satellite proeider's data centre, the ingoing e-mails are stored. An onboard system on the aircraft starts an e-mail retrieval by sending a retrieval command to the next satellite. The satellite forwards the retrieval command—if necessary via further satellites—to a ground station which is also known as gateway. The ground station of the satellite provider retrieves the stored e-mails from the data centre of the satellite provider and forwards them to the aircraft via the satellite from which the request was sent or, if necessary, via a neighbouring satellite.

For reasons of simplicity, the satellite provider's data centre and the satellite provider's gateway are not shown in FIG. 1. Also, FIG. 1 only shows only one satellite 27 of the global satellite network.

The aircraft 11 sends outgoing messages to the next available satellite 27. The satellite 27 forwards the outgoing messages to a ground station of the satellite provider, if necessary via further satellites. The ground station of the satellite provider forwards the outgoing messages to the data centre of the service provider.

The abovementioned processing of the data messages comprises a transformation of the original data messages using a meta language. The meta language comprises definitions and rules which define the transformation of a data message into a transformed message. The definitions and rules of the meta language define furthermore the reverse transformation of the transformed message into the original data message. The transformation of a data message comprises a text substitution of text based data content of the data message, or may comprise a full message substitution if a standard template type message is used. Both the text substitution and the template type substitution are based on lookup tables which are synchronised between the ground-based system and the aircraft-based system on the aircraft 11. The lookup tables are stored in a data storage medium of a computer onboard the aircraft 11 and in a data storage medium of a computer at the service provider's data centre, respectively.

Furthermore, the processing of the data messages comprises an insertion of additional flight and aircraft related information such as a destination address of an aircraft 11 taken from other computer applications or systems in the aircraft-based system for example, the aircraft-based system contains a flight plan which describes the departure point, destination and route details of a flight which are automatically inserted into messages when required. Locations and waypoints and turning points in the flight plan are described using a series of codes known as location codes and are a four letter alphabetical character set. Each location code or waypoint or turning point is known to the aircraft-based system which also contains other details such as the geographical coordinates of these positions. Messages in this system are encrypted via an encryption procedure such as public key encryption and/or symmetric encryption and compression via a binary compression algorithm such as ZIP, LZO etc.

In summary, a meta language according to the application comprises the following components and aspects:
a static dictionary or look-up table which is preloaded as per airline/aircraft/route definition
a context driven dictionary which is built dynamically based on mission details such as flight number, departure, destination, altitude, hotlist, etc.
a sequence driven dictionary which is built dynamically based on a sequence of flight stages or of messages, for example for e-mail threads, weather data, NOTAM etc.
transmission of delta messages which comprise information that has changed relative to an earlier message
transmission of repeat messages wherein information that is repeated from an earlier message is replaced by an identifier

The static dictionary of an aircraft which comprises tail sign, aircraft type, airline information, substitution codes etc. stays onboard of the aircraft. A portion of the dynamic dictionary which comprises, among others, message threads and message contents and part of the NOTAM and weather data is cleared after a session. Another portion of the dynamic dictionary which comprises, among others, aircraft routes, aircraft rotation, SMS and E-mail addresses and another part of the NOTAM and weather data is kept between successive sessions, for example to allow for a pattern recognition.

Below, lookup tables are shown for incoming messages for the flight crew. By way of example, a lookup table for NOTAM and a lookup table for weather reports are shown.

TABLE 1
look-up table for NOTAM messages

| element | meta code | meaning |
|---|---|---|
| NOTAMN | 0 | new NOTAM |
| NOTAMR | 1 | replacing previous NOTAM |
| NOTAMC | 2 | clearing previous NOTAM |
| EGTT | 3 | flight information region “London” |
| NBO | 4 | three letter abbreviation for NOTAM |
| | | purpose |
| 000 | 5 | default lower limit |
| 999 | 6 | default upper limit |
| Location | 3a | Identification of the location |
| Location | 3b | Location coordinates |
| coordinates | | |
| DUE | 17 | due |
| WIP | 18 | work in progress |
| TWY | 19 | taxi way |
| SOUTH | 20 | south |
| CLSD | 21 | closed |
| BTN | 22 | between |
| AND | 23 | and |
| DIVERTED | 24 | diverted |
| VIA | 25 | via |
| NEW | 26 | new |
| GREEN | 27 | green |
| CL | 28 | centre line |
| BLUE | 29 | blue |
| EDGE | 30 | edge |
| LGT | 31 | lighting |

In the case of NOTAM which contains the location of an airport, this location is identified by a four-letter location indicator allocated to that airport by ICAO. The ground-based system and the aircraft-based system hold a listing of location indicators in their synchronised look-up table databases as the location indicators to which the airline operates. As a location indicator known to the database look-up table, the location is allocated a numeral or other symbol. As a known location, the coordinate values for the airport are in the database system and are automatically inserted from the database look-up table when required by Item Q), for example when a radius is shown in the NOTAM.

According to the application, a field value can be left out when it is known from the context. This applies for example for the departure and destination airports of aircraft which fly on a regular schedule like the one shown in the schedule table below:

| Route No | DAY | DEP | DEST |
|---|---|---|---|
| 1 | MON | WMKK | EGSS |
| 2 | TUE | EGSS | WMKK |
| 3 | WED | WMKK | WIII |
| 4 | WED | WIII | WMKK |
| 5 | THU | WMKK | WSSS |
| 6 | THU | WMSS | WMKK |
| 1 | FRI | WMKK | EGSS |
| 2 | SAT | EGSS | WMKK |
| 3 | SUN | WMKK | WIII |
| 4 | SUN | WIII | WMKK |

This kind of schedule table, also known as aircraft rotation schedule, is stored on the aircraft in an aircraft database and in a database of the ground based system. the schedule table is synchronized between the ground station and the aircraft after a change of the aircraft schedule.

The following lookup table shows a portion of a lookup table for TAF (terminal area forecast) data. Similar tables may be constructed for other weather data such as METAR and SIGMET.

TABLE 2
look-up table for TAF messages

| keyword | meta code | meaning |
|---|---|---|
| TAF | 50 | terminal aerodrome forecast |
| TAF AMD | 51 | TAF amendment |
| TAF CNL | 52 | TAF cancellation |
| LFPO | 57 | Paris Orly flight information region |
| NIL | 53 | no information available |
| CNL | 54 | cancel |
| KT | 55 | knots |
| KMH | 56 | km/h |
| SKC | 57 | sky clear |
| FEW | 61 | few clouds |
| SCT | 62 | scattered clouds |
| BKN | 63 | broken cloud layer |
| OVC | 64 | overcast |
| CAVOK | 70 | ceiling and visibility ok |
| 9999 | 85 | visibility in excess of 10 km |
| FM | 80 | from |
| BECMG | 81 | becoming |
| TEMPO | 82 | temporary |
| INTER | 83 | intermittent |
| PROB | 84 | probability |
| TSRA | 85 | thunder storm with rain |
| MOD TURB | 101 | moderate turbulence |
| MOD/SEV | 102 | moderate to severe turbulence |
| TURB | | |
| SEV TURB | 103 | severe turbulence |
| BLW | 104 | below |
| FT | 105 | feet |
| TILL | 106 | until |

Airports to which the airline operate are allocated a specific location code by ICAO. A location is identified by a four-letter location indicator allocated to that airport by ICAO. The ground-based system and the aircraft-based system hold a listing of location indicators in their synchronised look-up table databases as the location indicators to which the airline operates. As a location indicator known to the database look-up table, the location is allocated a numeral or other symbol. Instead of decimal codes, as shown in the tables, hexadecimal codes including the characters A-F or also codes including other characters of a character alphabet such as the ASCII or the UNICODE alphabet may be used.

The code words may be all different, as shown in the examples or the set of code words for one message type may also overlap with the set of code words for another message type. One or more look-up tables may be used. The several look-up tables are also referred to as “the look-up table” as they can be regarded as a single look-up table.

In a structured message format such as the TAF format, the meaning of a field value can be derived from a context which is provided by the position of the word in the text and/or by a keyword at the beginning of a group of words. For example, if a sequence of data fields is contained in the message which are separated by predetermined field delimiters and which data fields always occur in the same order, the content of the data field can be derived from the position of the data field. According to the application, the same meta codes can be used for different words of a message text if the meaning of the meta code is uniquely defined by this context. Thereby, the meta codes can be made shorter.

In a further embodiment, the meta codes are ordered according to a word frequency, wherein shorter codes are attributed to more frequent words. The word frequency order is defined by an initial estimate and can be updated between the aircraft and the ground system based on the frequency of words in messages that were previously exchanged with the aircraft.

For example, if now snow fall is unlikely on the chosen flight route, the words TAF, customer.service@ff.net and SNOW may be arranged advantageously in the following coding sequence:

| Sample Keyword | meta codes |
|---|---|
| TAF | 0 |
| customer.service@ff.net | 12 |
| SNOW | 436789 |

A simple TAF message may have the following structure:

| | | Date, | | | | | |
|---|---|---|---|---|---|---|---|
| | | Time | | | | Cloud | Cloud |
| Type | Location | (UTC) | Validity | Wind | Visibility | amount | height |
| TAF, | ICAO | 051730Z | 0518/0624 | 14008KT | 3SM BR | FEW, | 010 |
| TAF AMD, | | | | | | SCT, | |
| TAF COR | | | | | | BKN, | |
| | | | | | | OVC | |

By way of example, an encoding of such a type of TAF message is provided below. The TAF type is represented by a two bit code, with TAF=00, TAF AMD=01, TAF COR=11. The airport code is represented by a dictionary number of an airport dictionary. The Z of the date and time field, which refers to “UTC-time” is omitted and, furthermore, the remaining number 51130 is represented in hexadecimal form as C7BA.

According to the application, encoding can also be done by converting the value to the sixteen bit binary number 11000111,10111010 which in turn can be represented by the two 8-bit ASCII characters 199=“ç” and 186=“°”. In the validity date, the value “0518” is omitted. The date information was already contained in the date/time field. The hour of validity is encoded by 3 bits since a TAF validity hour can only be 6, 9, 12, 15, 18, 21, 24 or 30. In the wind field, the unit “KT” is omitted, the angles 0-356° are encoded by 9 bits and the wind velocities 0-99KT by 7 bits. In the visibility field, the unit SM (statute miles) is omitted and the value is encoded by a binary number. The values of the cloud amount field are encoded by a 2 bit code according to 00-FEW, 01-SCT, 10-BKN, 11-OVC. The leading zero of the cloud height field is omitted and the value is encoded by a binary code.

A further example is provided by wind data encoding: the value 14008 represents a wind angle of 140° and a wind speed of 8 knots. In a binary representation this becomes (11011010 111000)₂. This may be interpreted as (11011010)₂=xDA=218=“ [symbol] ” and (00111000)₂=x38=56=“8”. A total range from 0°, 0 knots=0 to 359°,99 knots=35999 is needed. This requires 16 Bits or two 1-Byte chars, or three six or seven Bit characters. If a text message is expressed as a reduced 6-Bit subset of 7-bit ANSII, which is possible for NOTAM, three 6-Bit chars may be used for binary encoding, depending on the required value range. Three 6 bit chars allow to represent a value range from 0 to 2̂(3*6)=262144, whereas encoding with two six bit chars allows a value range from 0 to 4096. Number encoding with the complete 6 bit charset is equivalent to using a 64-base system.

The numeric values may also be left out or replaced by a placeholder and be shifted to the end or to the beginning of a message text. In this way, the Bits that represent numeric values can be arranged together in a compact way while the reading order of the Bits/Bytes that represent characters is preserved. The numbers may also be recoded such that more frequent values are attributed shorter Bit Codes.

According to the application, the length of an encoded message can be reduced even further by only transmitting the changed portion relative to the last messages. This applies for example to TAF messages of airport weather conditions. Very often, the weather forecast for an airport does not change drastically between successive TAFs.

For example, the following a TAF and a later TAF amendment may be provided by Singapore Changi Airport:

| | | Date, | | | | | |
|---|---|---|---|---|---|---|---|
| | | Time | | | | Cloud | Cloud |
| Type | Location | (UTC) | Validity | Wind | Visibility | Amount | height |
| TAF | WSSS | 050000Z | 0500/0512 | 14008KT | 3SM BR | FEW | 10 |

and

| | | Date, | | | | | |
|---|---|---|---|---|---|---|---|
| | | Time | | | | Cloud | Cloud |
| Type | Location | (UTC) | Validity | Wind | Visibility | Amount | height |
| TAF | WSSS | 050600Z | 0506/0512 | 14008KT | 3SM BR | FEW | 10 |
| AMD | | | | | | | |

Further fields are omitted here for the sake of simplicity. Then, assuming that the further fields are unchanged or not relevant, the second message may be encoded according to the application as the following delta message:

| Prev TAF | Release Δ | Validity Δ |
|---|---|---|
| <Ref code> | 6 hrs | 6 hrs |

wherein “<Ref Code>” stands for a reference to the previous TAF from the same airport. The reference code is needed to provide the recipient, which is usually an aircraft, with the information relative to which message the difference needs to be computed. Advantageously, the reference code is a counter which provides a means to the recipient to detect a lost message and to request a retransmission. The messages may be counted separately for each data type (NOTAM, Wx, TAF, etc.) to obtain smaller counter numbers. Furthermore, the message counter may be reset when a predetermined maximum number is reached, for example 10 000. A retransmission may be triggered when a numbering gap is detected upon receipt of a message or also after a timeout.

Even when the second message has more differences with respect to the third, the amount of transmitted Bits can be decreased significantly according to the application.

For example, a TAF message may comprise the following data:

| | | Date, | | | | | |
|---|---|---|---|---|---|---|---|
| | | Time | | | | Cloud | Cloud |
| Type | Location | (UTC) | Validity | Wind | Visibility | amount | height |
| TAF | WSSS | 050530Z | 0506/0518 | 14008KT | 3SM BR | FEW | 10 |

and a later TAF amendment may comprises the following data:

| | | Date, | | | | | |
|---|---|---|---|---|---|---|---|
| | | Time | | | | Cloud | Cloud |
| Type | Location | (UTC) | Validity | Wind | Visibility | amount | height |
| TAF | WSSS | 050700Z | 0507/0518 | 18012KT | 4SM BR | BKN | 25 |
| AMD | | | | | | | |

Then, according to the application, the following delta message is transmitted:

| Prev | | Release | Validity | | Visibility | Cloud | Cloud Ht |
|---|---|---|---|---|---|---|---|
| TAF | TAF AMD | Δ | Δ | Wind Δ | Δ | Amt | Δ |
| Ref | 2 bit | 1.5 hrs | 1 hr | 40, 4 | 1 | 10 in | 15 = F |
| code | (01) | | | | | binary | in hex |

A similar procedure can be applied when the second message is not a TAF amendment but an independent TAF message from the same source.

For example, a first TAF message may look like this:

| | | Date, | | | | | |
|---|---|---|---|---|---|---|---|
| | | Time | | | | Cloud | Cloud |
| Type | Location | (UTC) | Validity | Wind | Visibility | amount | height |
| TAF | WSSS | 050530Z | 0506/0518 | 14008KT | 3SM BR | FEW | 10 |

and a second TAF message may look like this:

| | | Date, | | | | | |
|---|---|---|---|---|---|---|---|
| | | Time | | | | Cloud | Cloud |
| Type | Location | (UTC) | Validity | Wind | Visibility | amount | height |
| TAF | WSSS | 051130Z | 0512/0524 | 20015KT | 4SM BR | BKN | 25 |

Taking into account the differences between the first and the second message, the second message may be represented as:

| | Release | Validity | | Visibility | | Cloud Ht |
|---|---|---|---|---|---|---|
| Prev TAF | Δ | Δ | Wind Δ | Δ | Cloud Amt | Δ |
| <Ref code> | 6 | 6 | 60, 7 | 1 | BKN = (10)₂ | 15 = xF |

wherein “BKN” is represented by the binary code 10 and the height difference of 1500 feet is represented by the hexadecimal code “F”.

Furthermore, the data media at the aircraft 11 and at the service provider's data centre contain a lookup table with passenger related information when this information has been provided by passenger to the airline for use with communications onboard the aircraft. The passenger related information may relate to electronic devices of a passenger such as IMEI numbers of mobile phones, e-mail addresses, MAC addresses or to the passenger or to luggage of the passenger.

TABLE 3
look-up table for passenger information

| | meta | |
|---|---|---|
| keyword | code | meaning |
| 490135-24-874165-5 | 2#A | IMEI of mobile device |
| 357977-03-8728315 | 2#B | IMEI of mobile device |
| 09-00-2B-00-00-04 0 | 2#C | MAC address of computer |
| dispatch@flightdispatch.com | 2#D | e-mail address |
| 0496978072656 | 2#E | telephone number |
| 490135-24-874165-5 | 2#A | IMEI of mobile device |
| 357977-03-8728315 | 2#B | IMEI of mobile device |
| 09-00-2B-00-00-04 0 | 2#C | MAC address of computer |
| dispatch@flightdispatch.com | 2#D | e-mail address |
| 0496978072656 | 2#E | telephone number |

Furthermore, the data media at the aircraft 11 and at the service provider's data centre contain a lookup table for routine messages and their related addressee(s). The look-up table comprises codes for each routine message and for the associated message addressee(s). Some of the routine messages contain data fields in which information can be entered. Those routine messages are referred to as “message templates”. The data fields of the message templates comprise free text fields within which arbitrary text may be entered, numerical data fields and selection data fields. The selection data fields comprise one of a selection of a limited number of items. According to the application, the aircraft based system may comprise specialized text based user applications which make use of message templates and text substitution via a meta code. For example, an airborne stock broker application may be provided which comprises templates for buying and selling stocks and meta codes for trading locations. The content of the data fields of the message templates may also be encoded to limit the length of the transmitted data still further. By way of example, a routine message lookup table is shown in Table 4 below.

TABLE 4
example look-up table for routine messages:

| | | meta |
|---|---|---|
| message or field value | Example Addressee(s) | code |
| REQ METAR [location] | fltflw@flflw.com; | M1 |
| | aocops@airline1.com | |
| REQ TAF [location] | fltflw@flflw.com; | M2 |
| | aocops@airline1.com | |
| REQ NOTAM [location] | fltflw@flflw.com; | M3 |
| | aocops@airline1.com | |
| REQ FUEL ON ARR [KG] | fltfuel@fltfuel.com; | M4 [KG] |
| | aocops@airline1.com | |
| meal type A | meals@airfeed.com | A |

The lookup table 4 comprises requests form METAR, TAF and NOTAM messages from a predefined location. In the context of the current flight, the requests are encoded as M1, M2 and M3, respectively. In this example, if the flight crew wish to request the METAR for the destination of the flight as M1, the onboard system application automatically inserts the meta code substitution for the four-letter location code taken from the flight plan without the need for further input from the flight crew. For example, the location code for Singapore, Changi airport is WSSS, the lookup table may hold this as airport 50. The addressees for this type of message are pre-determined, meaning that the aircraft-based and ground-based systems know who the message must be sent to, therefore there is no requirement for the flight crew to enter any specific addressees to the message. Thus, the workload of the flight crew and the length of the data message are significantly reduced. In the case of the REQ METAR (location), the message exchanged between aircraft-based system and the ground-based system is reduced to “M1;50” or even “M150”. If a general weather report without specification of a specific location is requested, the content “50” of the data field is left out, and only the message identifier “M1” is transmitted.

The routine message may comprise further data fields which may be required or optional. In the fourth routine message in Table 4, a fuel request is encoded as M4 and the numerical data field which states the amount in kg is left un-encoded. The fifth line contains a routine message in the form of a request for a meal type. The location of the destination airport is stored at the service providers' data centre through the synchronisation process carried out between the aircraft-based system and the ground-based system and the encoding device automatically inserts the airport location code. As in the previous example of a routine message, the routine message may comprise a variable data field that specifies the number or the type of meals being ordered. In this example, a certain meal type such as vegetarian meal may be coded as V.

In addition, the lookup table may also comprise message templates for passenger related messages, for example for requesting, modifying or cancelling passenger related services at a destination airport via a mobile phone of a passenger on the aircraft 11 such as booking a hire car for arrival or for requesting a certain type of information to be sent to the aircraft.

The substitution mechanism will now be explained by the example of a data transformation for a TAF weather message.

When the aircraft requires information of a certain type or when it is determined that the aircraft is to receive information of a certain type, the ground based system requests, in a first step, a message of this type from an external agency or reads a message of this type from a database. For example, a TAF (terminal aerodrome forecast) message may have been received the following information and the ground-based system may have determined that this message is of interest to a specific flight:
TAF LFPO 160000Z 160624 13018KMH 9000 BKNO20 BECMG 0608 SCT015CB BKN020 TEMPO 0812 17025G45KMH 1000 TSRA SCTO10CB BKN020 FM1230 15015KMH 9999 BKN020

The TAF message comprises a first information block, which contains the type of message (TAF) and the airport code LFPO and is followed by further information blocks. The first information block comprises information about the issue data and the expiry data of the TAF message and the current weather conditions at the airport. The further information blocks comprise information about predicted weather conditions. The further information blocks are introduced by keywords such as FM, TEMPO, PROB, BECMG, which are followed by a beginning of a time interval or a time interval. Further information about weather formats such as METAR or TAF is available from official bodies such as the World Meteorological Organisation (WMO) International Civil Aviation Organization (ICAO) or the US National Oceanic and Atmospheric Administration.

In a second step, a header is added to the TAF message. The header comprises the type of the message and the addressee(s). In a third step, the message is encoded by an encoding device.

In a first encoding step, the encoding device uses the above-mentioned substitution table to transform the TAF-message into the following message:
50;57;160000Z160241301856;9000;63;020;81;0608;62;015CB;63;020;82;08 12;17025G45;56;1000;85;62;010CB;63;020;80;1230;15015;56;85;63;020.

A delimiter, such as “;”, is inserted to separate the data fields. The numerical data fields that contain times, such as 160000Z160241301856, 0608, 0812, 1230 or other data, such as 13018, 015CB, 020, 17025G45, 1000, 010CB, 020, 15015, 020 are not encoded. The numerical fields are underlined here for ease of reference. In this example for a TAF message encoding, a 10,8% reduction of the TAF message length from 148 to 132 characters is achieved.

In a second encoding step, the encoding device compresses and encrypts the TAF message, according to known methods of compression and encryption. In a synchronizing step, a synchronizer splits the message into frames which comprise a synchronization block and further message blocks. In a transmission step, a ground-based communications device transmits the frames to the aircraft 11.

In a receiving step, an aircraft based communications device receives the data frames. In a synchronization step, an air bound synchronization device reassembles the data frames to an encoded message. In a first decoding step, a decoding device of the airborne system decrypts and decodes the message according to known methods. In a second decoding step, the decoding device uses a lookup table which is similar to the previously shown table 1 and the structure of the TAF message to find the coded text portions and to reinsert the original text into the TAF message.

The decoder uses a decoded data field to identify a following or a preceding numerical data field according to a set of rules. A set of rules for the abovementioned example would be given by the following rules. If a data field is the third field of a TAF message, decode it as issue time. Likewise, if the data field is preceded by a code for a time expression such as 81=BECMG, 82=TEMPO and 80=FRM, decode it as time field. If the data field is followed by a code for a velocity unit such as 56=KMH, decode it as wind velocity. If the data field is preceded by the codes 61=FEW, 62=SCT or 63=BKN or if the data field is followed by the unencoded cloud type keyword CB (cumolonimbus), If the data field is at the second position in the weather information of the initial group, decode it as visibility. In addition, the decoder uses the digit length of a numeric field to differentiate the numeric field from a code of an encoded key word.

In an extraction step, a message filter device extracts relevant information from the message header. An onboard computer initiates appropriate actions according to the information in the message handler. For example, it displays the information in a suitable format, for example as a graphical representation of the phenomena on one of two pilot information screens, and, subject to the nature of the information, may also alert the flight crew by means of an aural or visual indication on the cockpit display units.

Similarly, the encoding device would encode the following NOTAM message
A1234/06 NOTAMR A1212/06
Q)EGTT/QMXLC/IV/NBO/A/000/999/5129N00028WO05
A)EGLL
B)0609050500 C)0704300500
E)DUE WIP TWY B SOUTH CLSD BTN ‘F’ AND ‘R’. TWY ‘R’ CLSD BTN ‘A’ AND ‘B’ AND DIVERTED VIA NEW GREEN CL AND BLUE EDGE LGT.
   using the above mentioned lookup table into
A1234/06;1;11212/06
Q)3/QMXLC/IV/4/A/5/6/3b;005
A)3a
B)0609050500 C)0704300500
E)17;18;19;B;20;21;22;F;23;R.
19;R21;22;A;23;B;23;24;25;26;27;28;23;29;30;31

In the abovementioned example for a NOTAM message encoding, the number of characters has been reduced from 233 to 153 characters, thus a reduction of the NOTAM message length by 34% has been achieved. Details of the NOTAM format are published by the International Civil Aviation Organization (ICAO).

In the case of a routine message, for example a request for a weather report (METAR), a typical plain language representation of the message would comprise an address field, a from field and a message field. The encoding device would, in accordance with the application, encode a typical request message:

Flightfollowing@fltflw.com; aoc@airline.com

### FLT123

### REQ METAR WSSS

### As:

### M1;50

In this example, that of a routine message using a template, the addressee(s) of the message are pre-determined by the type of the message, the aircraft from which the message has been originated is known to the ground-based system, the request type is pre-determined from a series of pre-determined message types held in the aircraft and ground-based systems, and, in this case the location is the destination, then the location is known to the system and contained in the look-up table. The resulting message transmission is message M1=Request METAR <destination>, and location=50. The number of characters is reduced from 63 to 5, thus reduction in size is in the order of 92%.

FIGS. 4 and 5 show a syntax diagram for the parsing of METAR messages with a parser. Before a text substitution takes place, a parser parses the METAR message according to the syntax diagram of FIGS. 4 and 5. Likewise, a parser parses a received encoded message before decoding takes place. Data elements of the METAR message are read into variables in a computer readable memory. According to the substitution table, the data elements are replaced with a substitution code. A similar parsing process is also used for other standardized types of messages such as NOTAM, SIGMET and TAF which can be described with syntax diagrams similar to the syntax diagram of FIGS. 4 and 5.

According to the syntax diagram of FIGS. 4 and 5 a message parser identifies the various data fields of a TAF message and reads in the values of the data fields. The message parser is comprised in the encoding device as well as in the decoding device. In a first parsing step, the type 70 of the TAF message is determined. The type may be a standard message (TAF) or an amendment (TAF AMD) or a correction to a previous message (TAF COR). Next, the parser reads in a location 71 and an issue time 72 of the TAF message. After that, the parser reads in the initial group 73 of the TAF message. If the initial group 73 is a NIL field or if the initial group 73 is a cancellation message, the parser reads in the initial group and terminates. Otherwise, the parser reads in the weather information of the inital group 73 which comprises either “ceiling and visibility OK” (CAVOK) or at least the visibility (VIS), weather (WX) and cloud conditions (CLD) data fields.

After that, the parser reads in further message groups, which comprise temperature groups 74, significant change groups 75, significant weather variation groups 76, significant visibility variation groups 77 and significant turbulence groups 78. The parser also reads in data fields between the data groups. The data fields between the data groups comprise, among others, remarks (RMK), barometric pressure (QNH) and temperature (TEMP). The forecast weather conditions may be stated as changes which are preceded by the keywords FM (from), BECMG (becoming) or TEMPO (temporary) as in the message groups 75, 78. Or they may be stated as probabilities which are preceded by the keyword PROB as in the message groups 76, 77.

FIG. 7 shows an alternative embodiment 10′ of a flight information system. Apart from the elements shown in FIG. 1, the flight information system comprises an ACARS adapter 85 which is connected to a back office 86 of a customer airline. The ACARS adapter 85 performs an adaptation of a message protocol that is used by the flight information system 10′ to the ACARS protocol. A second aircraft 11′ sends and receives messages from and to the service provider's data centre 33 via a ground station 87 that is connected to the ACARS adapter 85. In other embodiments, the ground station 87 may also be connected to the service provider's operations support 34 or to the service provider's data centre 33 via the ACARS adapter 85.

In a further refinement of the previous embodiments, the meta language is applied in a dynamic way for each flight by allocating a dynamic code for the departure point and destination of a flight, rather than allocating a fixed meta code to a particular location. For example, the departure point for a flight is always allocated a meta code 1 and the destination is always allocated a meta code 2 irrespective of which particular locations these are or the aircraft that is undertaking the flight. The application of the dynamic code allocation is part of the synchronisation that takes place between the ground-based system and the aircraft-based system, inasmuch that the ground system knows the flight route from the schedule information obtained from the airline data sources, thus these aspects of the flight are known to each part of the system.

The dynamic text substitution according to the application is achieved via variable entries of the look-up table as well as by entries which comprise a link to variable data. The variable data comprises, among others, the flight route, the crew attributes, the payload of the aircraft, the equipment and parts on board of the aircraft. Furthermore, the look-up table may also comprise links to static data which is stored on board of the aircraft 11, or on the ground station. The variable data, too, is referred to as “identity related data”. According to the application, a portion of the dynamic data is cleared after a session and another portion is retained in a computer memory in order to allow pattern recognition and/or statistic analysis over several sessions. A session may be defined by a mission of the aircraft. The storing of data over multiple sessions allows a more efficient text substitution while the clearing of the data may be necessary or advantageous for reasons of privacy, for saving storage space or for discarding unnecessary information.

Part of the variable data and the static data that is substituted in the substitution process is updated as part of a synchronization process between the aircraft and the ground based system, for example at the service provider's data centre 33. The synchronization process is mainly carried out on the ground, for example through a Bluetooth data link, but also when the aircraft is in the air, for example through satellite or the aircraft telecommunication network. The synchronization process updates the data on the aircraft 11 and stores the current data content of the aircraft 11 on a computer readable medium at the ground based system.

By way of example, a content of a look-up table which comprises dynamic data is shown below. In a second table, code allocations based on allocation rules for dynamically allocating the data to code words are shown. The allocation rules may be implemented by storing the dynamic data in a column of the lookup table or also by a retrieving process. In the case of the aircraft 11, the retrieving process retrieves the dynamic data from the data content of the aircraft 11 or from devices onboard the aircraft 11. At the side of the service provider's data centre, the retrieving process retrieves the dynamic data from a data base in the ground based system. As shown below, the dynamic data may itself comprise multiple attributes. For example, the turbine blade carries as attributes the manufacturer and the part number.

The abovementioned message processing steps of the embodiments, for example the data retrieving and text substitution processes, are carried out automatically and may be realized by a computer readable program which may be stored in a computer readable memory or also be hard-wired in a circuit or a combination of both.

An example of meta codes which relate to dynamic content which may change from mission to mission or even continuously is given by the following table:

| data or data link | meta code |
|---|---|
| departure airport | 1 |
| destination airport | 2 |
| GPS position | 5 |
| current time | 6 |
| first captain | 10 |
| last health check of first | 11 |
| caption | |
| turbine blade | 20 |
| third call from passenger X | C3 |
| Recipient of SMS message 5 | R5 |
| from passenger X | |

Data which are known to the recipient may be expressed by a placeholder which is then filled with the corresponding data by the recipient or they may also be left out from the message if data refers to a predetermined position of a data field. By way of example, such data may include the following:

| data field | data |
|---|---|
| departure airport | HAM (Hamburg) |
| destination airport | SIN (Singapore) |
| GPS position | N54°45.0′ W3°15.5′ |
| current time | 12:30 |
| first captain | Mrs Brown |
| last health check of first | 5.4.2003 |
| captain | |
| turbine blade | factory = Rolls Royce |
| | part number = 12345 |
| third call from passenger | dialled phone number = 0157 3333 |
| | forwarded = 11:00PM |
| | calling cost = 20 units |

In an exemplary embodiment, an outgoing message is sent to replace a turbine blade at the destination airport. Using the abovementioned template substitution, the message is coded as template with a template code “T1” and parameters “1” and “20” for the destination airport and the part to be replaced. Thus, the text message consists essentially of the code words “T1”, “1” and “20” only. The message is arranged into data packets and transmitted to the ground based system. At the ground based system, the data packets are reassembled. Using the look-up table and the allocation rules, the code words are replaced with the corresponding data.

In this example, further information is deduced from the context of the message and is added to the message. The further information contains, for example, the arrival time of the aircraft and the address of the part supplier. In general there may be substitution data, such as the address of the part supplier, which is not stored on the aircraft 11 but only on the ground based system and which does not form part of the data which is synchronized between the aircraft 11 and the ground based system.

In another example, an outgoing SMS message is sent from a passenger device to a destination on the ground. The aircraft based system detects, that the SMS message is directed to the same recipient as the third message from the same phone. In an outgoing message, the recipient's phone number is replaced by the code word “3”. At the ground based system, the phone number of the recipient is retrieved from a list of previously dialed phone numbers from that passenger and the code word is replaced with the recipient's phone number. As mentioned previously, the sender of the message may be coded by a code word and the ground based system may retrieve any attributes of the sender from a ground based data base and insert the attributes of the sender into the message or use them for further processing of the message.

In a further embodiment, the abovementioned text substitution for SMS messages is applied to e-mail messages from or to the passengers and/or the flight crew.

The feature of dynamic code allocation or text substitution is provided in addition to the feature according to the application to contain a static meta code wherein certain meta codes are allocated on a fixed basis, for example those used in the encoding and decoding of standard message types such as NOTAM and weather messages.

The dynamic code allocation comprises two allocation methods, firstly an allocation of meta codes that is dynamic and context driven, for example for keywords used in the case of a flight plan, or a preset listing of company airports or company addressees, and, secondly, a code allocation method which is dynamic and sequence driven, for example when sending email type messages, a flight-specific stack is created and the outgoing messages are numbered. When a second or subsequent message carries a same address to that used previously, only the short form code is used, as this address is already known to the system.

FIG. 8 illustrates a significant weather chart 100 and information extraction from the significant weather (SIGWX) chart 100. The SIGWX chart 100 comprises textual and graphical content which can be static or dynamic. The static content relates to fixed geographical features like boundaries of continents etc. The dynamic content relates to weather conditions as well as other temporal changes in the atmosphere like volcano eruptions, the release of other hazardous substances into the air, sandstorms, etc. According to the application, the static content of the SIGWX chart 100 is stored in a database onboard the aircraft while the dynamic content of the SIGWX chart 100, or part of it, is transmitted to the aircraft in a compressed format.

The dynamic graphical content of the SIGX chart 100 comprises, among others, wind trajectories 101, weather region boundaries 102 and cloud boundaries 103. The significant weather chart 100 may furthermore comprise weather fronts and movement indications of those weather fronts, which are not shown in FIG. 8. According to the application, the dynamic graphical content is approximated and transformed into a textual content. In FIG. 8, an approximated wind trajectory 101′ and an approximated cloud boundary 103′ are shown. In particular, trajectories and region boundaries are approximated by straight segments and endpoint coordinates of the straight segments are included in an encoded message. These endpoint coordinates are also known as “geo snap-points”. The endpoint coordinates may be stated as absolute longitude and latitude or also relative to a reference point which may be another endpoint of a segment.

The dynamic textual content of the SIGWX chart 100 comprises text as well as symbols like wind strength flags, active volcano symbols, turbulence strength symbols and other symbols. In particular, FIG. 8 shows cloud condition labels 105, clear air turbulence (CAT) area identifiers 105, turbulence data 106, volcano data 107, a tropical cyclone symbol, tropopause height indicators 109 and an active volcano symbol 110. The SIGWX chart may also comprise further symbols which are not shown in FIG. 8, such as symbols for icing conditions.

A conversion of wind data according to the application will now be explained in detail. By way of example, in the upper left corner of the SIGWX chart 100 a wind trajectory 101 is shown with four wind vectors displaying wind velocities of 120, 140, 120 and 100 knots. The wind trajectory 101 refers to winds within the flight level 390, which is indicated below the wind vectors. Below the second wind vector, an upper and a lower boundary of a 80 knot isotach is given. Changes of the wind velocity by 20 knots may be indicated by pairs of hash marks which are oriented perpendicular to the wind trajectory.

In one exemplary embodiment, the wind data for the wind trajectory is encoded using a geographic latitude, longitude positions and difference vectors as the four entries 28,27,120,390;3,12,+20,0,300,470;−1,12,−20,0;−3,12,−20,0;

These values represent a wind trajectory which starts at 28°,27° latitude and longitude at flight level 390. It is piecewise represented by start point (28,27) and the difference vectors (12,3), (12,−1) and (12,−3). The wind speed changes are +20 knots, −20 knots and −20 knots, respectively. In a graphical representation, the resulting windspeeds 140, 120 and 100 are placed next to the start point of a vector. The second entry comprises a lower and an upper boundary of a 80 knots isotach at flight level 300 and 470, respectively. Values “0” indicate an unchanged reference flight level and may also be left out. The four wind data entries may be obtained from a grid based format by transforming a wind trajectory 101 into the approximate trajectory 101′ by edge recognition and linear interpolation.

Similarly, an approximate cloud boundary 103′ which comprises 8 linear segments may be represented by a starting point and 7 difference vectors. The difference vectors may also be split into clockwise and anticlockwise difference vectors. In another embodiment, the 7 endpoints of the 8 segments may be represented as absolute positions relative to the starting point. This avoids an adding up of inaccuracies while still reducing the length of the meta code. A similar method can also be used to transmit the ten clear air turbulence areas of FIG. 9.

By transmitting the coordinates of supporting points or of difference vectors, the amount of data is reduced significantly. An aircraft based application may transform the coordinates into a smooth line by using interpolation algorithms such as spline based, polynome based or other interpolation algorithms.

The remaining textual data comprises attributes to graphical data like the cumulonimbus upper and lower boundaries and the turbulence indications of the CAT areas. In this case they are associated together with the text based representation of the graphical data. Other textual data is not attached to any graphical data, such as the tropopause heights. This data is associated together with geographical coordinates. For example, the 500 tropopause height at the Australian west coast may be represented by 500, 12, 113.

Flight levels are stated in hundreds of feet above normal pressure level and are provided in intervals of 1000 feet. For a high level SIGWX chart as for international flights, the flight levels in the chart have a range of 250 to 630, as indicated in the information box below Africa. This partitioning results in 63−25+1=39 different levels. These may be coded by meta codes 0 to 38. The flight level L is recovered from the meta code n by the formula L=250+n*10.

According to the application, the graphical and other data may be derived from an image format by recognition algorithms such as edge detection and OCR. If a text based format such as BUFR (binary universal form for the representation of meteorological data) is available, this may be used instead or in addition as input data for an aircraft weather message.

According to the application, delta messages may also be used for SIGWX charts. For example, a moving circular region may be represented by the following two messages:

| Latitude | Longitude | Radius |
|---|---|---|
| 48.5178 | 5.2042 | 8 |

and

| Latitude | Longitude | Radius |
|---|---|---|
| 48.5471 | 5.1552 | 5 |

Then, according to the application, the second message may be represented by the following delta message:

| Latitude | Longitude | Radius |
|---|---|---|
| 0.0293 | 0.049 | 3 |

Thus, only the value difference needs to be transmitted. If it can be assumed that the difference never exceeds a predetermined range, then the difference can be encoded by a fixed length variable which is shorter than a variable for encoding the absolute values. Alternatively, a variable length encoding may be used. In this case it is advantageous to indicate the actual length of the variable, for example by flag bits, by leading and trailing blank spaces or other separators. The delta encoding method can also be applied to polygons and trajectories which are defined by a set of coordinates, for example to the wind trajectories and cloud regions. A message may comprise difference data as well as absolute coordinate values along with other content.

FIG. 9 illustrates a meta language encoder/decoder 120. The meta language encoder/decoder 120 transforms plain data 121 into encoded data 122 and encoded data 122 into decoded data 121 using a data type specification 123 that is sent together with the plain data 121 or in the encoded data 122. Furthermore, the meta language encoder/decoder 120 uses a dynamic dictionary 124 and a static dictionary 125 for a text substitution of keywords.

FIG. 10 shows a data encoding process using the meta encoder/decoder 120. Plain data 121 is provided with a message header 126 that contains a message type 123. The message type is associated with a flags in a message handling table, such as a priority flag, a security flag, a compression flag etc. The meta encoder/decoder 120 uses the static library 124 and the dynamic library 125 to generate compressed data 122. Based on the message type, the message is encrypted and or signed by an encryption means 127 using checksums, hash sums, signatures, biometric signatures or others to obtain encrypted data 129. The compressed data 122 or, respectively, the compressed and encrypted data 129 is passed on to a data slicer 130 which slices the data into data packets if the data exceeds a predetermined maximum packet length. The data packets are transmitted via a network 132, for example a satellite network which may use a short burst, circuit switched or other protocol or, for example, via a short range WLAN and internet connection.

FIG. 11 shows an aircraft database which comprises all the static data load that the flight information system requires onboard the aircraft, among others an airport list, an airways list, airspaces list, waypoints list, flight information region (FIR) list, NOTAM list, a wind list. Part of this information is distributed as part of an AIRAC cycle. The aircraft database 133 comprises a subset database 134 which comprises the mission specific data and which is generated from the more comprehensive general information in the aircraft database 133. The mission specific data comprises, among others, airports, airways, airspaces, FIRS, NOTAMS and wind data which are specific to the chosen flight route of the present mission. The subset database 134 has a shorter identifier than the aircraft database 133, for example with 2 instead of 32 digits, such that the amount of transmitted data is reduced. The generation of the subset database 134 from the aircraft database 133 is carried out in the same way in the ground based system, in order to obtain the same result.

FIG. 12 shows a thread recognition based message encoding according to the application. The aircraft based system and the ground based system provide means for recognizing message threads. On both the sender and the receiver side, e-mail or SMS messages are stored in a message cache of a computer readable memory.

In step 120, a message to be sent is read into a memory. In step 121 previously sent messages from the same messaging device are read in from a message cache. In step 122, previous messages within the message to be sent are automatically identified. If a previously sent message (or message content) is detected, this message content is replaced by an identifier, for example a counter in step 123. In step 124 the new message content, which was not previously sent, is stored in the message cache. Alternatively, the original message or the shortened message may be stored in the message cache. In step 125, the shortened message is transmitted, for example by a radio link and a satellite network.

FIG. 13 shows a generation of a delta-message. In step 130, a message to be sent is read in. In step 131, a message type of the message is identified, for example by reading out a message header or by document parsing. In step 132, a previous message of the same type is read in from a message cache of a computer readable memory. By comparison of the message with the previous message, data fields with unchanged data are identified in a step 133. Further more, data fields with changed data are identified in a step 134. In a step 135, difference values between new and old values are computed. In a step 136, additional data fields which were not present in the previous message are identified. In a transmission step 137, a delta message is sent which comprises the difference values and the additional data.

On the receiver side, the identifier is used to retrieve the previously sent message content and the identifier is replaced with the previously sent message content. Thereby, the amount of transmitted data can be reduced considerably. Shortly before or after a flight mission or shortly before a landing the message cache may be deleted for privacy reasons.

In addition to sent messages, previously received messages which are received by the same messaging device may also be stored in a message cache and substituted by an identifier in a similar way. For example, the messaging device may be provided by a mobile phone, tablet or other PC or also by a personal messaging device which is connected to the aircraft

If thread portions are already marked by a unique identifier, a time consuming identification of text portions on the sender side can be avoided. Respective message caches on receiver and sender side according to the application allow for a message substitution in message threads on both sides of a bidirectional communication. An identifier of a thread portion is assigned by the message originator side and transferred to the receiver along with the message.

While the thread recognition based substitution allows to save space in a computer memory, a more important advantage is the reduction in an amount of transmitted data.

The use of a meta language according to the application provides numerous benefits and advantages.

Flight safety is enhanced by reducing flight crew workload and by making an increased amount of up-to-date operational data and information available to the flight crew for use during flight.

The use of a global satellite network and specifically the use of a short burst data service according to the application provides a low cost global communications coverage which is less prone to range limitations, or disruptive influences. Through inter-satellite networking of the global satellite network, the number of required ground stations can be reduced to one only. Advantageously, the satellite network uses satellites with essentially polar orbits to ensure a good worldwide coverage including the poles.

According to the application, an inbuilt mechanism is provided to keep costs as low as possible by reducing bandwidth requirements through the use of techniques to transform messages into a much smaller character set whilst retaining the security of messaging and preserving the meaning and intent, consistent with international standards for the preservation of data integrity whilst in storage and transit.

In addition, the use of the global satellite network according to the application makes it possible to provide a growing amount of data and information into the cockpit in a cost effective way and without lengthy delays in messages being delivered to recipients, for example for use in airborne internet applications. Apart from the use of compression techniques, the application also provides alternative strategies for data transfer to derive the greatest benefits for users.

In contrast to voice messages, text messages according to the application occupy little bandwidth, can be pre-prepared and/or pre-populated from other aircraft systems using a system of templates and computerised software commands, parsed and processed reliably and can be generated automatically and be sent by a ground-based system simultaneously to many aircraft. The content of the text messages can be used in various ways, for example to show flight related data on a pilot's display or to show positional information relating to the progress of a flight at a ground-based airline operations control position.

A reduction of the message length of an aircraft related message according to the application reduces the cost and the required time to send and receive messages. Through the efficient use of the available bandwidth, a flight information system which is provided primarily for use by the flight crew can also be used to provide text based services to the passengers, such as SMS services.

Through the use of a look-up table according to the application, which contains a content that is optimized for a flight of an aircraft, the length of an aircraft related message can be reduced efficiently. The use of predefined message templates allows for an even better reduction of message length. For certain standard cases, a single code word can replace the whole content of a long message.

According to the application, the message length is still further reduced by the use of context sensitive text substitution. Compared to a fixed look-up table, the size of the look-up table and thus also the number and size of the code words can be kept small by reducing the entries of the code table to those entries which are relevant in the current context, for example for the current flight of the aircraft. Furthermore, a context sensitive text substitution allows to encode also that information which is only known in the current context.

According to the application, data which is stored at a receiver's side and which is linked to an identifier or code word contained in a received message can be retrieved from a database and inserted in the text message. Thus, the transmission of data which is already known to the receiver can be avoided.

According to an embodiment of the application there is no constant connection but, instead, a connection is established each time when outgoing data is sent which provides an efficient use of the available bandwidth.

An encoding method according to the application, which makes use of a look-up table which is known to the sender and the receiver, but in general not to a potential eavesdropper, also provides a basic level of security. For example, it is made difficult to insert false messages without deciphering the meaning of the code words. The security may be further enhanced by changing the code words associated to a data field or a message in regular intervals, for example when the aircraft is on the ground and the stored look-up table on board of the aircraft is synchronized with a stored look-up table on the ground.

Although the above description contains much specificity, these should not be construed as limiting the scope of the embodiments but merely providing illustration of the foreseeable embodiments. Especially the above stated advantages of the embodiments should not be construed as limiting the scope of the embodiments but merely to explain possible achievements if the described embodiments are put into practise. Thus, the scope of the embodiments should be determined by the claims and their equivalents, rather than by the examples given.

Further aspects of the application are disclosed by the following list of items,

Item 1. Method for transmitting an encoded aircraft related message, the method comprising
receiving an aircraft related text message for encoding;
identifying a message type of the text message;
generating an encoded message by
   reading in keywords;
   identifying groups of at least one keyword to be encoded;
   looking up code words for the groups of at least one keyword in a look-up table;
   replacing the groups of at least one keyword to be encoded by the code words;
deriving a destination message from the encoded message;
arranging the destination message into at least one data packet, wherein the length of the at least one data packet is variable;
generating a short burst data signal from the data packets;
transmitting the data signal via an antenna.

The length of the variable length data packet is dependent on the amount of data such that little or no extra bits need to be transmitted, as is often the case with a fixed length data packet. The length of a data packet is bounded by a predefined maximum data length above which the message has to be split up into several data packets. The destination message can be transmitted with a data packet service. etc. sender and receiver address can be included. A network technology that breaks up a message into small packets for transmission. Unlike circuit switching or duplex radio connections, which requires the establishment of a dedicated point-to-point connection, each packet in a packet-switched network contains a destination address. Thus, all packets in a single message do not have to travel the same path. As traffic conditions change, they can be dynamically routed via different paths in the same network or in different networks, and they can even arrive out of order. The destination computer reassembles the packets into their proper sequence.

Packet switching is advantageous for handling messages of different lengths, as well as different priorities, providing quality of service (QoS) attributes, where included. Packet switching is designed for data and. using the IP protocol, packet networks are also useful for voice and video.

Item 2.

Method according to item 1 further comprising steps of
arranging the destination message into at least one variable length data packet, wherein the length of the at least one data packet does not exceed a pre-defined maximum data length of a short burst data service;

Item 3.

Method according to one of items 1 to 2, further comprising steps of
generating a short burst data pulse;
transmitting the short burst data pulse via an antenna.

Item 4.

Method according to one of the previous items wherein a global low orbit satellite network is used. Thereby, a global coverage for aircraft ground communication is provided.

Item 5. Encoding Device for encoding an aircraft related message according to one of items 1 to 4 comprising
a message processing device for processing an aircraft related message, the message processing device comprising
a text substitution unit with a computer readable memory, computer readable memory comprising a lookup-table,
a communications device for arranging the aircraft related message into data packets of a pre-determined maximum size.

Item 6. Encoding device according to item 5, the text substitution unit further comprising
a message segmentation unit with a computer readable memory, the computer readable memory comprising a maximum length of a short burst data payload (e.g. in bits);

Item 7. Encoding device according to item 6, the encoding device further comprising
a modem which is adapted for generating short burst data pulses

Item 8. Decoding Device for decoding an aircraft related message, the aircraft related message having been encoded with a device according to one of the items 5 to 7 comprising
a receiving device for receiving the aircraft related message;
a message reassembling unit;
a text substitution unit with a computer readable memory, the computer readable memory comprising a look-up table;
a computer readable memory for storing an output of the text substitution unit.

Item 9 Data link, the data link comprising
an encoding device according to one of items 5 to 7 for encoding an aircraft related message,
one or more satellites of a global satellite network for forwarding short burst data signals of the encoding device, wherein the short burst data signals are derived from the output of the encoding device
a gateway of a global satellite network for receiving short burst signals from the one or more satellites and for deriving segments of an encoded aircraft related message from the short burst data signals
a decoding device according to item 8 for decoding the aircraft related message.

Further aspects are also disclosed in the following list of items.

Item 1. Method for decoding an aircraft related message, the method comprising
receiving at least one data packet;
deriving an aircraft related message from the at least one data packet;
forwarding the aircraft related message to a data processing unit;
identifying a message type of the message; if the message type is a template
   replacing a template identifier with a stored template text;
   inserting numerical values from the message into predefined positions of the template text;
else
   identifying message portions to be decoded;
   reading in identifiers of message portions to be decoded corresponding to one or several code words;
   looking up code words in a look-up table;
   replacing the identifiers of the message portions to be decoded by the corresponding code words;
   outputting the decoded message to an output destination.

Herein, the template identifier stands for a template for a complete message text, as opposed to a template for just a group of code words within a message, such as the group representing the meaning “cloud cover is increasing to value XX”. However, parameter values and headers may be added to the template identifier to form the message to be transmitted. The decoding may also comprise a step of reinserting information that was left out as part of the encoding.

Item 2 Method for transmitting an encoded aircraft related message, the method comprising
receiving an aircraft related text message for encoding;
identifying a message type of the text message, the message type being selected from a template, a standard message or a free text message;
generating an encoded message by
   reading in keywords;
   identifying groups of at least one keyword to be encoded;
   looking up code words for the groups of at least one keyword in a look-up table;
   replacing the groups of at least one keyword to be encoded by the code words;
   deriving a destination message from the encoded message;
   arranging the destination message into at least one data packet;
   generating a data signal from the data at least one data packet;
   transmitting the data signal via an antenna.

The encoding may furthermore comprise a step of leaving out words which are known or can be deduced by the recipient, for example a unit of wind speed, the departure airport.

Item 3. Method for decoding an aircraft related message, the method comprising
receiving a short burst data signal;
deriving an aircraft related message from the short burst data signal;
forwarding the aircraft related message to a data processing unit;
identifying a message type of the message; if the message type is a template
replacing a template identifier with a stored template text;
inserting values from the message into predefined positions of the template text for forming a complete message text
outputting the decoded message to an output destination.

### REFERENCE NUMBERS

11 aircraft
13 bluetooth communication channel
14 first data network
27 satellite
32 second portion of satellite communication channel
33 service provider's data centre
34 operations support centre
35 airport
36 airport
37 airport communication channel
39 airline communication channels
40 airline offices
41 second secure connection
42 second data network
50 base transceiver station
51 switching module of the BTS
52 mobile terminal devices
54 antenna of the BTS
55 base station controller
56 satellites
57 switching unit of the BSC
58 mobile switching centres
60 IP-backbone
70 type of a TAF message
71 location
72 issue time
73 initial group of
74 temperature group
75 significant change group
76 significant weather variation group
77 significant visibility variation group
78 significant turbulence group
85 ACARS adapter
86 back office of customer airline
87 ground station
100 SigWX chart
101 wind trajectory
101′ simplified wind trajectory
102 CAT region boundary
103 cloud region
103′ simplified cloud region
104 cloud label
105 CAT region label
107 volcano data
108 tropical cyclone symbol
109 tropopause height
110 volcano symbol
120-125 method steps
130-13
700 ground based system
701 external agencies
702 message types
703 database
704 input/output encoding/decoding device
705 address
706 synchronisation device
707 ground based communications device
708 encrypted communications channel
800 aircraft based system
801 communications device
802 message synchronisation device
803 content in process
804 input/output encoding/decoding device
805 lookup table
806 message types
807 cockpit display device

1. Message transmission device for transmitting messages between an aircraft and a ground station comprising
a computer readable memory for storing aircraft related text messages, wherein the memory further comprises a look-up table,
means for detecting a message data type of the text message,
means for retrieving identity related data,
means for retrieving meta codes from the look-up table based on the message data type and on the identity related data,
means for replacing words or groups of words in the text message by the meta codes to obtain an encoded message,
means for deriving a data signal from the encoded message,
means for transmitting the data signal to a recipient.

2. Message transmission device according to claim 1, wherein the look-up table comprises at least one meta code which is dependent on an airline code, an aircraft tail number, an aircraft rotation schedule, an aircraft route, a session data, a multi-session data.

3. Message transmission device according to claim 1 or claim 2, the message transmission device further comprising
a memory, the memory comprising a message cache for storing transmitted messages.

4. Message transmission device according to claim 3, further comprising
means for deriving word frequencies of a word from the transmitted messages in the message cache,
means for attributing meta codes to words based on the word frequencies and for storing the meta codes in the lookup-table.

5. Message transmission device according to claim 3, further comprising
means for identifying a current numerical value of a data field of the message,
means for identifying a previous numerical value of the same data field in a previously sent message in the message cache,
means for computing a value difference between the current numerical value and the previous numerical value,
means for including the value difference into the message.

6. Message transmission device according to one of the claims 1 to 5, the message transmission device further comprising
an aircraft based database, means for receiving identity related data from a ground station/ground based system,
means for generating a look-up table with words and associated meta codes based on the identity related data,
means for storing the lookup-table.

7. Message transmission device according to one of the claims 1 to 6 further comprising
means for converting a numeric value into a b-adic value with b>10,
means for including a word which represents the b-adic value into the message.

8. Message transmission device according to one of the claims 1 to 7 further comprising
means for converting a numeric value into a binary representation,
means for adding additional bits to the binary representation such that a total number of bits is a multiple of a number of character bits to obtain an encoded value,
means for including the encoded value in the message.

9. Message transmission device according to one of the claims 1 to 8, the message transmission device comprising
a message cache,
means for identifying a numerical data field in a message to be sent, the message being formatted according to a predetermined message format,
means for retrieving a first numeric value from the numerical data field in the message to be sent,
means for retrieving a second numeric value of the same data field in a previously sent message in the message cache,
means for computing a difference between the first numeric value and the second numeric value,
means for encoding the difference,
means for inserting the encoded difference in a message to be sent,
means for transmitting the message.

10. Transmission link comprising a message transmission device according to one of the claims 1 to 9 and further comprising a message receiving device, the message transmission device further comprising
means for including a message counter into messages to be sent,
the message receiving device comprising:
means for comparing the message counter with a previously received message counter,
means for detecting, based on the comparison, that a lost message has not been sent,
means for requesting a resending of the lost message if it is detected that the lost message has not been send,
means for delaying decoding of a received message until the lost message has been received, the lost message comprising a data field which is not included in the message or wherein the message comprises a data field with a value that is dependent of the value of the same data field in the lost message.

11. Message transmission device for transmitting messages between an aircraft and a ground based system, the message transmission device comprising
means for retrieving a latency identifier from a message header,
means for evaluating the latency identifier,
means for determining a condition for the message to be sent, based on the latency identifier,
means for testing the condition,
means for initiating a sending of the message if the condition is met.

12. Message transmission device according to one of the claims 1 to 9, the message transmission device further comprising:
means for deriving an aircraft position,
means for determining a relevance of a message to be sent, based on the aircraft position,
means for initiating a sending of the message if the message is determined as relevant.

13. Message transmission device according to one of claims 1 to 9, the message transmission device further comprising
means for identifying a path in a weather chart,
means for approximating the path by straight line segments,
means for representing endpoints of the straight line segments by a plurality of coordinates,
means for including the coordinates in a/the message to be sent.

14. Device for updating an aircraft based substitution dictionary, comprising
means for receiving identity related data for the dictionary from a ground based system,
means for generating a lookup table with words and associated meta codes based on the identity related data,
means for storing the identity related data and the substitution list in an aircraft based database,
means for storing the code list with words and associated meta-codes in the aircraft based database.

15. Device for updating a ground based substitution dictionary, comprising
means for retrieving a code list with words and associated meta-codes from an aircraft,
means for storing the code list with words and associated meta-codes to a database at a ground station.

16. Message transmission device comprising:
a reception unit for receiving an aircraft related text message for encoding;
a processing unit for retrieving, based on the aircraft related text message, identity related data being related to the identity of a sender of the message or to the identity of a receiver of the message from a database, for processing the aircraft related text message, for generating an encoded message using a text substitution process which is based on the identity related data, and for deriving a destination message from the encoded message, wherein the processing unit further arranges the destination message into at least one data packet;
a communication unit for generating a data signal from the at least one data packet and for transmitting the data signal via an antenna.

17. Receiver device comprising
a communication unit for receiving at least one data signal and for deriving at least one data packet from the at least one data signal,
a processing unit for arranging the at least one data packet into an aircraft related message, for extracting at least one code word from the aircraft related message, for retrieving identity related data based on the at least one code word from a database, and for processing the aircraft related text message and generating an encoded message using a text substitution process which is based on the identity related data,
an output unit for outputting the decoded message to an output interface.

18. Communication link comprising a receiver device of claim 17 and a message transmission device of one of the aforementioned claims.

19. Aircraft with a receiver device according to one of the aforementioned claims.

20. Aircraft with a sender device according to one of the aforementioned claims.

21. Method comprising
receiving an aircraft related text message for encoding;
retrieving, based on the aircraft related text message, identity related data being related to the identity of a sender of the message or to the identity of a receiver of the message;
processing the aircraft related text message and generating an encoded message using a text substitution process which is based on the identity related data;
deriving a destination message from the encoded message;
arranging the destination message into at least one data packet;
generating a data signal from the at least one data packet;
transmitting the data signal between an aircraft and a ground based system.

22. Method according to claim 21, further comprising a step of synchronizing at least part of the identity related information between the sender and the receiver.

23. Method according to claim 21 or claim 22, wherein the text substitution process comprises steps of
reading in at least one text portion, the at least one text portion comprising identity related data;
looking up a code word for the at least one identity related text portion in a look-up table;
replacing the at least one identity related text portion by the code word.

24. Method according to one of claims 21 to 23, wherein the text substitution process comprises steps of
determining a message type of the aircraft related message;
if it is determined that the message type is a template;
choosing an identity related template, based on a template number which is contained in the message and based on the identity related data;
replacing the template number with a number of the identity related template;
determining if the template comprises parameters;
if it is determined that the template comprises at least one parameter:
looking up a code word for the at least one parameter in the look-up table;
if a code word is found in the look-up table:
replacing the at least one parameter with the code word.

25. Method according to one of the claims 21 to 24, wherein the text substitution process comprises steps of
reading in at least one text portion;
selecting a look-up table, based on the identity related data;
looking up a code word for the at least one text portion in a look-up table;
replacing the at least one text portion by the code word.

26. Method according to one of the claims 21 to 25, further comprising a step of
generating a short burst data signal from the data packets;
wherein the length of the last data packet is a variable length.

27. Method according to one of the claims 21 to 26, further comprising steps of
assigning a priority to the aircraft related message;
determining a condition for sending the aircraft related message;
determining if the condition for sending the aircraft related message is fulfilled;
if it is determined that the condition for sending the aircraft related message is fulfilled
arranging the destination message into at least one data packet,
generating a data signal from the at least one data packet;
transmitting the data signal via an antenna.

28. Method according to claim 27, wherein the determination of the condition for sending the aircraft related message comprises steps of
determining an actual position of the aircraft;
determining, based on the actual position of the aircraft, a location and a transmission method for the aircraft based message.

29. Method comprising
receiving at least one data signal;
deriving at least one data packet from the at least one data signal;
arranging the at least one data packet into an aircraft related message;
forwarding the aircraft related message to a data processing unit;
extracting at least one code word from the aircraft related message;
retrieving, based on the at least one code word, identity related data, the identity related data being related to the identity of a sender of the aircraft related message or to the identity of a receiver of the aircraft related message;
processing the aircraft related message and generating an encoded message using a text substitution process which is based on the identity related data;
outputting the decoded message to an output destination.

30. Method according to claim 29, wherein the step of retrieving the identity based information comprises
selecting a look-up table based on an identifier which is included in the aircraft related message;
retrieving the identity based information, based on the selected lookup-table and the at least one code word.

31. Method according to claim 29 or claim 30, wherein the step of retrieving the identity based information comprises
retrieving a data reference from a look-up table;
retrieving, based on the data reference, the identity related data.

32. Method comprising
receiving an aircraft related text message for encoding;
retrieving a message data type from a predetermined set of data types;
retrieving identity related data which is related to the identity of a sender of the message or to the identity of a recipient of the message;
retrieving meta codes of a look-up table, wherein the meta codes of the look-up table are dependent on the message data type and on the identity related data;
replacing words in the message by entries of the look-up table to obtain an encoded message;
deriving a destination message from the encoded message;
generating a data signal from the destination message;
transmitting the data signal via an antenna or via a portable data medium.

33. Method according to claim 32, wherein the identity related data is selected from an airline code, an aircraft tail number, an aircraft rotation schedule, an aircraft route, a session data, a multi-session data.

34. Method according to one of the claims 32 to 33, the method further comprising
storing transmitted messages in a message cache of a memory,
deriving word frequencies of a word from the transmitted messages in the message cache,
attributing meta codes to words based on the word frequencies,
storing the meta codes in the lookup table.

35. Method according to one of the claims 32 to 34, further comprising
storing transmitted messages in a message cache of a memory,
identifying previously sent messages of a message thread in a message to be sent using the message cache,
replacing the previously sent messages of the message thread by message identifiers.

36. Method according to one of the claims 32 to 35 further comprising steps of
identifying a template;
identifying a word that represents a numeric value;
replacing the template with a template identifier;
including the template identifier and the numeric value in the message.

37. Method according to one of the claims 32 to 36, further comprising
retrieving a numeric value from a message to be sent;
converting the numeric value into a hexadecimal value;
including a word which represents the hexadecimal value into the message.

38. Method according to one of the claims 32 to 37, further comprising
retrieving a numeric value from a message to be sent;
converting the numeric value into a binary representation;
adding additional bits to the binary representation such that a total number of bits is a multiple of a number of character bits to obtain an encoded value;
including the encoded value in the message.

39. Method for transmitting an aircraft related message according to one of the claims 32 to 38 further comprising steps of
identifying a numerical data field in a message to be sent, the message being formatted according to a predetermined message format,
retrieving a first numeric value from the numerical data field in the message to be sent,
retrieving a second numeric value of the same data field in a previously sent message,
computing a difference between the first numeric value and the second numeric value,
encoding the difference,
inserting the encoded difference in a message to be sent,
sending/transmitting the message.

40. Method according to one of the claims 32 to 39, further comprising steps of
retrieving a first numeric value from a previously sent message;
retrieving a second numeric value from a message to be sent;
comparing the first numeric value with the second numeric value,
if the first numeric value is equal to the second numeric value:
removing a data field that corresponds to the second numeric value from the message to be sent.

41. Method according to one of the claims 32 to 40, further comprising steps of
including a message counter into a message to be sent;
on receipt of the message:
comparing the message counter with a previously received message counter;
if it is detected, based on the comparison, that a lost message has not been sent:
requesting a resending of the lost message;
delaying decoding of a message until the lost message has been received.

42. Method according to one of the claims 32 to 41, the method further comprising:
determining a message type of the aircraft related message,
identifying a redundant word that represents a redundant information in the message;
removing the redundant information from the message to be sent.

43. Method according to claim 42,
wherein the redundant word represents a previously transmitted information.

44. Method according to claim 42 or 43,
wherein the redundant information is a word which is repeated within the message.

45. Method according to one of the claims 32 to 44, the method further comprising
identifying a path in a weather chart;
approximating the path by straight line segments;
representing endpoints of the straight line segments by a plurality of coordinates;
including the coordinates in the message to be sent.

46. Method according to claim 45, wherein the path represents a wind trajectory, the method further comprising
identifying a wind vector which is associated to one of the straight line segments;
determining magnitude and direction of the wind vector;
encoding magnitude and direction of the wind vector to obtain encoded wind data;
including the encoded wind data into the message to be sent.

47. Method according to claim 45 or 46, wherein the path represents a boundary of a weather region.

48. Method according to one of claims 45 to 47, the method further comprising
obtaining a relative coordinate by forming a difference between and endpoint of one of the straight line segements and a geographic location;
including the relative coordinate into the message to be sent.

49. Method for choosing a transmission mode for the trans-mission of a message between an aircraft and a ground based system, the method comprising
retrieving a latency identifier from a message header;
evaluating the latency identifier
if the latency identifier specifies immediate sending:
sending the message within a predefined maximum time limit;
if the latency identifier specifies a time limit:
collecting the messages in an aircraft based memory;
sending the collected messages before the specified time limit expires.

50. Method according to claim 49, the step of evaluating the latency identifier further comprising:
if the latency identifier specifies sending after landed:
collecting messages with the latency identifier “after landed”;
at the next stay at an airport:
transmitting the collected messages to a ground station via an antenna or via a portable data carrier.

51. Method according to claim 49 or claim 50, the step of evaluating the latency identifier further comprising: if the latency identifier specifies sending with archive:
collecting messages with the latency identifier “with archive”;
transmitting the collected messages at a predetermined time of exchanging an archive.

52. Method for determining messages to be sent to an aircraft comprising:
deriving an aircraft position;
determining a relevance of a message to be sent, based on the aircraft position;
if the message to be sent is determined as relevant:
sending the message to an aircraft;
if the message to be sent is determined to be not relevant:
discarding the message.

53. Method according to claim 52, wherein the step of determining the relevance of the message to be sent comprises:
determining a geographical range of the message;
comparing the geographical range with predetermined regions around present and future locations of the plane on a predetermined flight path;
if the geographical range of the message falls within the regions around present and future positions:
determining that the message is relevant.

54. Method according to claim 53, wherein the step of determining the relevance of the message to be sent further comprises:
comparing the geographical range with regions around a list of alternative airports, the list of alternative airports depending on the current position of the plane;
if the geographical range of the message falls within the regions around the alternative airports:
determining that the message is relevant.

55. Method for updating an aircraft based substitution dictionary, comprising steps of
receiving identity related data for the dictionary from a ground based system;
generating a substitution list with words and associated meta-codes based on the identity related data;
storing the identity related data and the substitution list in an aircraft based database.

56. Method for updating a substitution dictionary, comprising steps of
retrieving a substitution list with words and associated meta-codes from an aircraft based memory,
transferring the substitution list with words and associated meta-codes to a database in a ground station.
